(19) United States
(12) Patent Application Publication
(10) Pub. No.: US 2004/0025657 A1
(43) Pub. Date: Feb. 12, 2004

(54) Method of packing sheet recording materials and package for same

(75) Inventors: Noriyuki Hosoi, Minami-ashigara-shi (JP); Takayoshi Nakaseko, Minami-ashigara-shi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/386,684

(22) Filed: Mar. 13, 2003

(30) Foreign Application Priority Data
Mar. 14, 2002 (JP) 070346/2002

(51) Int. Cl. B26D 7/18

(52) U.S. Cl. 83/72

(57) ABSTRACT

Disclosed is a method of packing sheet recording materials comprising the step of cutting the sheet recording materials to a prescribed size and the step of packing the cut sheet recording materials into a packing material, wherein the cutting step and/or packing step is conducted in an environment with a degree of cleanliness of less than or equal to class 10,000 of U.S. Federal Standard 209d. No image defects are generated during use of the films contained in the package.

### TECHNICAL FIELD

The present invention relates to a method of packing sheet recording materials and a package for the same. More specifically, the present invention relates to a method of packing medical films and other sheet recording materials so that no image defects are generated during use of the films, and a package formed thereby.

### RELATED ART

Due to efficient mass production, sheet recording materials are normally manufactured to a size larger than that in which they are employed. They are subsequently cut to the size employed, a prescribed number of sheets are stacked and packed in a packing material, the packing material is sealed, and the product is circulated as a package. In this manner, sheet recording materials pass through at least the two steps of cutting and packing following manufacturing as they are transformed into packages.

A number of methods have been proposed for cutting sheet recording materials to a prescribed size.

For example, Japanese Patent Laid-open Publication (Kokai, henceforth referred to as “JP-A”) No. 8-47898 discloses a method of cutting photographic products and the device employed in the same. Based on this device, sheet recording materials are cut lengthwise to obtain multiple striplike recording materials. In this process, clean cutting is possible without the use of dangerous tools and the strips can be readily fed back to auxiliary devices. However, this Publication makes absolutely no mention of the environmental conditions employed during cutting.

Further, JP-A-2001-337411 discloses a method of cutting photothermographic materials and the device employed in the same. Based on this device, a photothermographic material can be cut well without relying on the shape of a blade or how well upper and lower blades are adjusted. Further, cutting by the device does not cause separation of the image forming layer of the photothermographic material and does not affect photographic properties. However, this Publication describes only the temperature condition as an environmental condition during cutting, affording no greater details of environmental conditions.

A certain number of sheets of sheet recording materials that have been cut to prescribed size are, for example, stacked and then packed into an inner carton such as that shown in FIG. 3, or a protective carrier such as is shown in FIG. 10. The inner carton containing a certain number of sheets of sheet recording material is then placed into a packing bag and degassed to reduce the pressure. The two ends are then heat sealed to achieve the sealed state shown in FIG. 4. Subsequently, as shown in FIG. 5, the two ends are folded up and secured with labels. As shown in FIG. 6, the product is packed into a cosmetic box with zipper (the zipper is denoted by numeral 7) and sealed with sealing tape (or a label) 8 to prevent tampering. A label 9 indicating the quality is then affixed to achieve the packaged state shown in FIG. 7. As indicated in FIG. 8, five boxes are then packed in a cardboard box 10, and as shown in FIG. 9, the flaps of cardboard box 10 are sealed with a hot melt adhesive and a sheet recording material package indicating the product name, period of use, lot number, product code, and the like is obtained. This series of packaging steps is conducted by suitably adjusting the ambient temperature and humidity. However, little attention is normally paid to other environmental conditions.

The sheet recording material is then circulated while in the package, removed from the box at the time of use, and employed to record an image. The sheet recording material is generally placed with the image recording surface facing down and packed into the bottom of the packaging material. Vibration and shock during transit cause the sheet recording material to be subjected to slight repeated vibration in the packaging material. Thus, the sheet packaging materials that are packed at the very bottom and top are more greatly affected due to surface contact with the packaging material. In particular, the recording surface of the bottommost sheet of recording material rubs against the bottom of the packaging material under the weight of the sheets of recording material stacked on it. Such friction sometimes causes damage such as scratches to the image formed on the sheet recording material. The reduction of such damage has become an issue.

When recording an image on a sheet recording material, an image recording device is generally employed. For example, when recording an image on a photosensitive sheet recording material, the unexposed sheets of recording material are prestored within a storage member shielded from light within the image recording device. When image recording is necessary, one sheet of the recording material is conveyed from the storage member, exposed and developed. Because it is necessary to reliably position multiple sheets of unexposed sheet recording material in the storage member, a pack of sheet recording material such as is shown in FIG. 4 is normally loaded into the storage member at once. Accordingly, it is necessary to smoothly convey a sheet of sheet recording material as needed from the pack that has been loaded into the storage member. However, there are conventional products presenting great resistance in the course of conveying a single sheet of recording material from the pack that has been loaded in the storage member, precluding smooth conveyance. Thus, there is a demand for a package that is highly reliable during use and capable of constantly and smoothly conveying sheets of recording material from the packing material once loaded into the storage member of the image recording device.

High image quality has been demanded of image recordings on sheet recording materials in recent years. In particular, image damage such as scratches and voids in medical images run the risk of causing misdiagnosis. Thus, particularly minute delineation is required of medical images. Further, even in non-medical images, images of high quality with good sharpness and graininess are being demanded.

However, image recordings on sheet recording materials do not consistently afford adequately high quality. In particular, even when the image recording device or sheet recording material itself is excellent, high quality is not always achieved at the actual site of use after the product has circulated in the market. The resolution of this problem has become an issue.

The present inventors considered that the main factors producing the image deterioration were in the process of cutting and packaging of sheet recording materials. The object of the present invention is to deal with these problems. That is, the object of the present invention is to provide a method of cutting sheet recording materials and packing the cut sheet recording material so that no image defects are generated during use of the films. A further object of the present invention is to provide a package wherein the sheet recording materials contained therein can be taken out easily and deterioration of the sheet recording materials is inhibited.

### SUMMARY OF THE INVENTION

The present inventors conducted extensive research to find that the above objects were achieved by determining the environmental conditions during cutting and packing of the sheet recording materials. The present invention was made on the basis of the findings.

The present invention provides a method of packing sheet recording materials characterized by comprising the step of cutting the sheet recording materials to a prescribed size and the step of packaging the cut sheet recording materials into a packaging material, wherein the cutting step and/or packaging step are conducted in an environment with a degree of cleanliness of less than or equal to class 10,000 of U.S. Federal Standard 209d.

The method of the present invention is particularly effective when the sheet recording material is a photothermographic material or a heat-sensitive recording material. The method of the present invention is more effective when the packing materials are cleaned prior to the packing step.

Further, the present invention provides a package for sheet recording materials packaged by the above-described method.

### BRIEF DESCRIPTION OF THE DRAWINGS

FIG. 1 is a plan view of the inner carton for heat-sensitive recording materials employed in Manufacturing Examples 1 and 2.

FIG. 2 is a plan view of the protective carrier for photothermographic materials employed in Manufacturing Examples 3 and 4.

FIG. 3 is a perspective view of a heat-sensitive recording material contained within the inner carton for heat-sensitive recording materials.

FIG. 4 is a perspective view of sealing and packaging within a sealing and packaging sheet.

FIG. 5 is a perspective view of a Wappen attached to the sealed packaging bag.

FIG. 6 is a perspective view of a sealed packaging bag packed in a cosmetic box with zipper.

FIG. 7 is a perspective view of a cosmetic box with zipper to which sealing tape and label have been applied.

FIG. 8 is a perspective view of cosmetic boxes with zippers stored in a cardboard box.

FIG. 9 is a perspective view of a sealed cardboard box.

FIG. 10 is a perspective view of a photothermographic material stored within a protective carrier for photothermographic materials.

FIG. 11 is a perspective view of a protective carrier.

FIG. 12 shows perspective views of packing materials containing a sheet recording material stored in a light-blocking bag.

### BEST MODE OF IMPLEMENTING THE INVENTION

The method of packing sheet recording materials and the package for sheet recording materials of the present invention are described below in detail. In the present Specification, ranges indicated with “-” mean ranges including the numerical values before and after “-” as the minimum and maximum values.

The present invention is characterized in that a cutting step and/or packing step are conducted in an environment with a degree of cleanliness of less than or equal to class 10,000 of U.S. Federal Standard 209d.

What is referred to here as a “U.S. Federal Standard 209d class” is a standard for clean rooms. The term “an environment with a degree of cleanliness of less than or equal to class 10,000 of U.S. Federal Standard 209d” means an environment in which the cumulative number of particles with a particle size of greater than or equal to 0.5 micrometer is less than or equal to 10,000 particles/ft³, and the cumulative number of particles with a particle size of greater than or equal to 5.0 micrometers is less than or equal to 65 particles/ft³.

An environment meeting these conditions can be created within a clean room. However, the present invention is not limited to being practiced in a clean room. That is, the devices used to cut and package the sheet recording material need not all necessarily be located within a clean room for processing. For example, a mechanism providing a gas flow to the sheet recording material may be provided within the cutting to packaging devices to maintain the sheet recording material in an environment with a degree of cleanliness of less than or equal to U.S. Federal Standard 209d class 10,000.

At least the cutting step or the packing step must be maintained at a degree of cleanliness of less than or equal to U.S. Federal Standard 209d class 10,000. Desirably, the cutting step environment is maintained at a degree of cleanliness less than or equal to U.S. Federal Standard 209d class 10,000, and preferably, both the cutting step and the packing step are maintained at less than or equal to U.S. Federal Standard 209d class 10,000.

The cutting step referred to in the present invention means a step in which the sheet recording material is cut to a prescribed size, normally a step in which it is cut to the size of use (A4, half-size, or the like). The number of cuts is not specifically limited, with one cut or multiple cuts being possible. It is also possible to form a recording material in the form of strips running to one end by collecting the sheets in the longitudinal direction and cutting, and then cutting the sheets in the traverse direction to prescribed size. The cutting means or cutting device employed during cutting is not specifically limited.

The packing step referred to in the present specification means a step comprising at least a step of packing the sheet recording material when the sheet recording material itself is loaded into an image recording device, and at least a step of packing the pack of sheet recording material when the sheet recording material is packed into a pack which is then loaded into an image forming device. That is, it means a step of packing the sheet recording material or pack of sheet recording material that is loaded into the image recording device. The packing means and packing device are not specifically limited.

Although the degree of cleanliness from cutting step to packing step need not necessarily be less than or equal to U.S. Federal Standard 209d class 10,000, it is desirable to maintain an environment of less than or equal to U.S. Federal Standard 209d class 10,000. The same applies during the period following manufacturing of the sheet recording material through to cutting.

The degree of cleanliness during the cutting step is desirably less than or equal to class 7,000, preferably less than or equal to class 4,000, more preferably less than or equal to class 1,000, and still more preferably less than or equal to class 500 as measured by U.S. Federal Standard 209d. The degree of cleanliness during the packing step is desirably less than or equal to class 7,000, preferably less than or equal to class 4,000, more preferably less than or equal to class 1,000, and still more preferably less than or equal to class 500 as measured by U.S. Federal Standard 209d.

According to the present invention, conducting the cutting step and/or packing step in an environment with a degree of cleanliness of less than or equal to U.S. Federal Standard 209d class 10,000 greatly reduces the risk of image defects being produced during image recording on the sheet recording material. Specifically, the generation of voids and scratches is greatly reduced during image recording on the sheet recording material.

In the present invention, the packing material employed to pack the sheet recording material is desirably selected from among materials tending not to generate dust. In particular, packing materials that preclude maintaining an environment with a cleanliness of less than or equal to U.S. Federal Standard 209d class 10,000 due to dust originating in the packing material are desirably not selected.

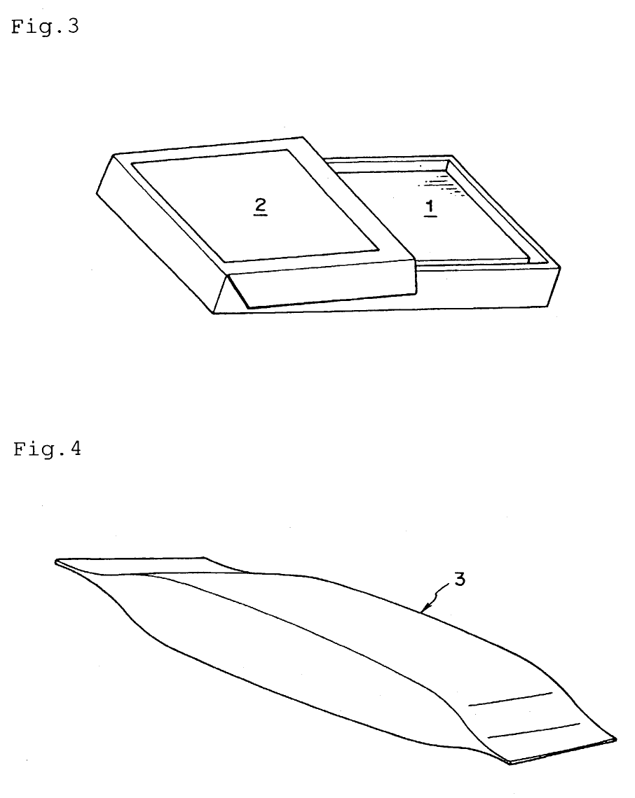

The sheet recording material is generally packed into a box member called a protective carrier or inner carton, or stacked on a platelike member which is then covered together with the sheet recording material in film or the like. The box member called a protective carrier or inner carton may have the structure shown in FIG. 3 or 10, for example. The box member comprises a bottom member functioning as a pedestal on which the sheet recording material may be placed, and desirably further comprises side members and a cover member. The cover member is provided to partially cover the side members and the top portion of the sheet recording material that is stacked, and is generally formed so as not to impede operation of the suction cup of the image recording device. The image recording surface of the sheet recording material is generally loaded face down on the bottom member or platelike member of the boxlike member.

The boxlike member or platelike member is desirably comprised of paper, a plastic such as polypropylene, or a laminate thereof.

Various materials may be employed. The material may be selected from among the materials described in “New Developments in Functional Packing Materials”, p. 33 and pp. 118-122, published by Tore Research Center. Preferred examples are polypropylene (such as the biaxially oriented polypropylene (Torefin YM-11) manufactured by Tore (K.K.), and the biaxially oriented polypropylene (OPA) manufactured by Nimura Kagaku (K.K.)) and polyethylene (with high-density polyethylene being preferred).

The laminate film may be comprised of multiple layers. Examples of the layer structure in such cases are (1) a laminate comprising a polymer, metal-comprising layer, and polymer in that order, (2) a laminate comprising a polymer and a metal-comprising layer in that order, and (3) a laminate obtained by vapor deposition of a metal. These may be laminated onto paper to form the bottom member. In the course of lamination, it is desirable for the paper to be surface treated in advance by corona discharge or the like. In the case of (1) or (2), the polymer contacting the paper can be employed as the adhesive with a hot-melt metal-comprising layer. Further examples are pressure adhesion and vacuum adhesion methods. The method of extruding polyethylene onto a sheet of paper that has been treated by corona discharge and adhering a sheet obtained by adhering a metal foil to a biaxially oriented polymer by vacuum adhesion is particularly preferred. The total thickness of the laminate film is desirably from 5 to 100 micrometers, preferably from 5 to 50 micrometers. The thickness of the paper alone prior to adhesion of the laminate film is desirably from 250 to 450 micrometers, preferably from 300 to 400 micrometers. The use of BKP or BSP as the pulp material is desirable. Among the materials in the laminate film, the thickness of the metal-containing layer is desirably from 1 to 40 micrometers, preferably from 2 to 20 micrometers.

The boxlike member or platelike member is desirably treated to suppress dust generation. This treatment is not specifically limited so long as it suppresses the generation of dust. Examples are calendering, supercalendering, cast coating, cast drying, and brush finishing treatments. The base material of the boxlike member or platelike member may also be coated or impregnated with resin, or a resin layer may be laminated. A method such as that described in JP-A-7-104432 may also be suitably employed.

A packing material that has been cleaned in advance is desirably employed in the present invention. Here, the term “cleaning” refers to an operation of removing dust and debris present on the packing material. Examples of cleaning methods are bringing the surface of the packing material into contact with an adhesive roller while driving it, and removing debris on the surface of the packing material by adhering it to an adhesive roller. Further examples are removing dust and debris on the packing material surface by means of static electricity and removing dust and debris by exposing the packing material surface to an air flow.

The packing material employed in the present invention desirably has a moisture content of less than or equal to 7% by weight, with from 1 to 4% by weight being preferred. What is meant here by the term “moisture content” is that measured by the method specified by JIS-P-8127.

The substance of the packing material employed in the present invention is not specifically limited. A paper material is preferred. The thickness of the paper material employed as the packing material is normally 0.2 to 0.7 mm, preferably 0.4 to 0.5 mm. The moisture content of the paper material is normally from 6 to 8.5% by weight during the manufacture of the original paper. Paper materials with a moisture content exceeding 7% by weight can be used in the present invention by drying them in a drying chamber to achieve the desired moisture content. The moisture content can be controlled by controlling the drying temperature and drying time.

Since the sheet recording material is packed into the packing material, portions potentially coming into contact with the sheet recording material desirably have smooth surfaces. The packing material must be able to adequately withstand the weight of the sheet recording material and protect the sheet recording material during transit and within the image forming device. The surface of the packing material may be treated to increase smoothness and/or strength. For example, a resin layer or the like may be coated on the surface.

The weight of the packing material is normally from 250 to 400 g/m², preferably from 270 to 360 g/m², and more preferably from 300 to 340 g/m².

The packing material employed in the present invention is not limited to a structure covering the entire sheet recording material, but may be a case member with an opening for loading and removal, such as a protective carrier, or have a structure contacting a portion of the sheet recording material (such as a platelike or “L” shape). A structure inserting easily into an image forming device such as an exposure device or image developer that does not develop problems during circulation is desirable.

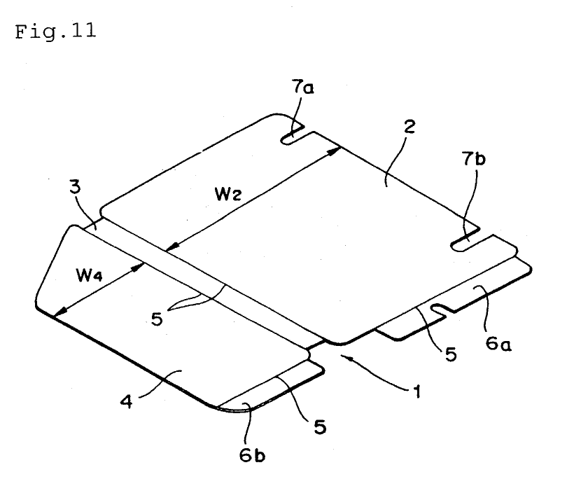

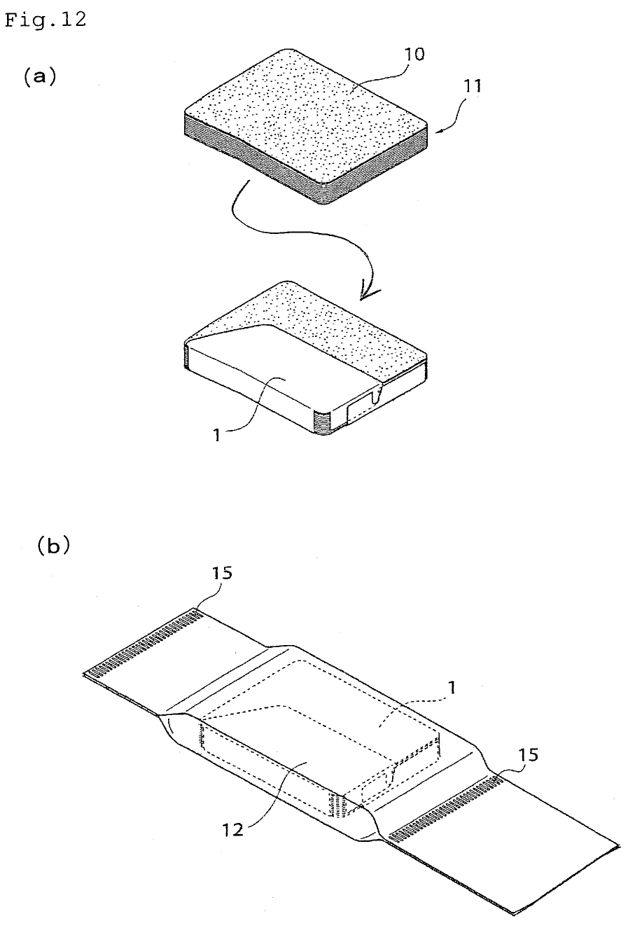

The structure of a protective carrier in the form of a typical packing material will be described with FIGS. 11 and 12. First, the material employed as the packing material is processed by punching into the shape shown in FIG. 11. In FIG. 11, bottom 2, connecting member 3, and top 4 have been integrated into a single member. Protective carrier (packing material) 1 can be fashioned by folding inward by about 90° along ruled lines 5. In the figures, 6a and 6b denote flaps and 7a and 7b denote notches. A stack 11 of sheet recording material 10 of prescribed size is loaded into protective carrier 1 as shown in FIG. 12(a). Bottom 2 of protective carrier 1 is roughly equal in size to sheet recording material 10. Notches 7a and 7b formed in bottom 2 are completely covered by sheet recording material 10 when it is loaded onto bottom 2. Stack 11 of sheet recording material is loaded so that the bottom, two sides, and a portion of the top are in contact with protective carrier 1.

The width W₄ of the top of protective carrier 4 is desirably greater than or equal to 50.5%, preferably greater than or equal to 51.5%, and more preferably greater than or equal to 53% the width W₂ of bottom 2. The upper limit is a width affording no obstruction during the removal of sheet recording medium 10. For example, when employing a device in which, during exposure, stacked sheet recording materials are subjected to suction by a suction cup for single sheets of recording medium (referred to hereinafter simply as a “suction cup”) and conveyed to the exposure element, it is necessary that there be a hole in the top large enough not to impede suction by the suction cup. The upper limit of width W₄ of top 4 of protective carrier 1 varies with the size of sheet recording material 10, but is desirably less than or equal to 70%, preferably less than or equal to 60%, of the width W₂ of bottom 2, for example.

The entire boxlike member in which the sheet recording material has been loaded, or the entire platelike member on which the sheet recording material has been stacked, is packaged with film or the like. For example, when employing a photosensitive sheet recording material, a light-blocking film is employed. Examples of light-blocking films are aluminum foil and polypropylene-laminated aluminum foil. Normally, a film on which aluminum has been vapor deposited or aluminum foil is employed. The method of the present invention may also be applied when directly packaging the sheet recording material with film without employing a boxlike member or platelike member.

The light-blocking bag may be prepared by joining facing sheetlike films having light-blocking properties with a heat seal or the like and processing them into a cylinder. A stack of sheet recording materials is then loaded into the cylindrical light-blocking bag, the bag is inserted into the protective carrier, degassing is conducted, and sealing is conducted with heat seals at position 15 shown in FIG. 12(b).

The degassing means is not specifically limited. Examples are degassing conducted with a device combining a vacuum pump and a degassing (suction) nozzle and degassing conducted with a vacuum chamber-type degassing device.

Degassing is conducted under conditions yielding a gas content within the light-blocking bag after sealing of desirably 3.2 to 460, preferably 65 to 330. The gas content referred to here is given by the following equation.

$$L = \frac{V}{n \times A} \times {10}^{5}$$

In the equation, L denotes the gas content, V denotes the volume of air (unit cm³) in the light-blocking bag, n denotes the number of sheets of recording material loaded into the packing material, and A denotes the area per sheet of sheet recording material (unit cm²). The air volume V within the light-blocking bag can be computed, for example, from the mass and volume of the overall pack and the weight of the pack in water according to Archimedes' method. In the present invention, the permitted volume of air V in the light-blocking bag increases in proportion with the number of sheets n of recording material. Further, the permitted volume of air V in the light-blocking bag increases in proportion with the area A per sheet of recording material.

The relative humidity in the sealed light-blocking bag is desirably from 5 to 55%, preferably from 10 to 40%, and more preferably from 20 to 35%. The humidity in the light-blocking bag varies with the moisture content of the packing material and light-blocking bag.

The two ends of the sealed light-blocking bag are subsequently folded onto the top and fixed with labels or the like. At that time, the heat seal that was applied when processing the sheetlike film having a light-blocking property into a cylinder is normally positioned at top center. The heat seal is thicker than other portions of the light-blocking bag, and tends to increase the specific gravity of the pack through external pressure. Thus, as set forth above, by making the width W₄ of the top of the protective carrier greater than or equal to 50.5% of the width W₂ of the bottom, the specific gravity exerted through the heat seal is exerted on the sheet recording material through the top of the protective carrier, protecting the sheet recording material.

In the present invention, a series of steps including the cutting and packing steps can be automatically and continuously conducted. In that case, it is desirable to provide suction or similar devices on the series of rubbing parts to remove any dust that is generated. For example, devices removing dust can be provided at slits in the recording material, cut portions, areas where the recording material is stacked, and in areas where the protective carrier and inner carton are conveyed. Further, dust can be removed in the step of packaging the pack that has been packed with film or the like into the cosmetic box, and in the step of loading the cosmetic box into the cardboard box. The method of the present invention can be effectively employed to obtain high-quality images with good sharpness and graininess. Among sheet recording materials, the method of the present invention is particularly effective when applied to materials developing images through the application of heat while in contact with a thermal head or heat roll, such as heat-sensitive recording materials and photothermographic materials. The method of the present invention is extremely effective when applied to medical materials in which there is a risk of misdiagnosis due to image damage.

Next, heat-sensitive recording materials will be described. The heat-sensitive recording materials are conventional sheet recording materials that can be packed in the package of the present invention.

The heat-sensitive recording material has a heat-sensitive recording layer and a protective layer on a support. The heat-sensitive recording material may have other layers if necessary.

When the heat-sensitive recording material has an intermediate layer, the protective layer is formed on the intermediate layer.

Next, heat-sensitive recording materials will be described. The heat-sensitive recording materials are conventional sheet recording materials that can be packed in the package of the present invention.

The heat-sensitive recording material has a heat-sensitive recording layer and a protective layer on a support. The heat-sensitive recording material may have other layers if necessary. When the heat-sensitive recording material has an intermediate layer, the protective layer is formed on the intermediate layer. The protective layer is formed by applying a coating solution for the protective layer. The coating solution for the protective layer contains at least a pigment and a binder. Further, in order to improve head matching performance and to obtain an excellent coated surface, the coating solution for the protective layer contains an emulsion of silicone oil, which is dispersed so that the average particle diameter thereof is 0.15 μm or less (the dispersed silicone oil will be occasionally simply referred to as the “silicone oil”, hereinafter). The coating solution for the protective layer contains other components if necessary.

While the silicone oil used in the present invention is dispersed so that the average particle diameter thereof is 0.15 μm or less, the average particle diameter is preferably 0.10 μm or less, and more preferably 0.08 μm or less. If the average particle diameter exceeds 0.15 μm, the emulsion of the silicone oil is damaged by strong stirring or ultrasonic irradiation, and huge oil droplets are formed. Accordingly, coating defects due to repelling may be caused easily. In the present invention, the average particle diameter of the silicone oil is indicated by values measured by a submicron particle analyzer (N-4-type, manufactured by Coulter, Inc.). The silicone oil used in the present invention is not particularly limited as long as the silicone oil is dispersed so that the average particle diameter thereof is 0.15 μm or less, and commercially available products may be used. Silicone oil whose average particle diameter exceeds 0.15 μm can also be used in the present invention by dispersing the silicone oil thoroughly so that the average particle diameter becomes 0.15 μm or less.

In order to disperse the silicone oil such that the average particle diameter thereof becomes 0.15 μm or less, a conventional dispersing machine such as a homogenizer, a dissolver, a colloid mill, or an ultrasonic emulsifier is used in the presence of an auxiliary dispersant such as polyvinyl alcohol or any of various types of surfactants, preferably a nonionic surfactant or alkylbenzene sulfonate. In such a manner, the silicone oil can be dispersed such that the average particle diameter thereof is within the above-described range.

While an ordinary polydimethylsiloxane can be used for the silicone oil, ether modified silicone oil, carboxy modified silicone oil, amino modified silicone oil, carbinol modified silicone oil, phenol modified silicone oil, and mercapto modified silicone oil are preferable, and ether modified silicone oil, carboxy modified silicone oil, and amino modified silicone oil are more preferable. A single type of silicone oil or a combination of two or more types of silicone oils may be used. These modified silicone oils may be modified at the side chain or at the terminal of the molecule.

The viscosity of the silicone oil used in the present invention is preferably 400 to 100,000 cps, and more preferably 1,000 to 50,000 cps. If the viscosity is lower than 400 cps, the surface of the protective layer feels sticky to the touch, and fingerprints may be left when the surface is touched by fingers. On the other hand, if the viscosity exceeds 100,000 cps, it is difficult to emulsify and disperse the silicone oil to the extent that an average particle diameter of 0.15 μm or less is achieved.

The added amount of the silicone oil used in the present invention is preferably 1 to 15% by weight and more preferably 2 to 10% by weight based on the total coating amount of the protective layer. If the added amount is less than 1% by weight, it may not be possible to obtain the effect of providing lubricating property with respect to the head. On the other hand, if the added amount exceeds 15% by weight, further effects may not be expected. Besides, ill effects such as fouling on the head might be caused.

The pigment is generally used to enable recording by a thermal head to be carried out better. Specifically, the pigment is used to reduce sticking and generation of noise and the like. It is preferable that an organic and/or inorganic pigment is used.

It is preferable that the pigment used in the protective layer is a pigment in which 50% by volume of the total volume of particles in the pigment is particles having a volume average particle diameter of 0.20 to 1.00 μm. This “50% volume average particle diameter” thus refers to the average diameter of 50% by volume of all of the particles of the pigment, and is measured by an apparatus for measuring distribution of particle diameters by laser diffraction, LA700, manufactured by Horiba Ltd. Hereinafter, the average particle diameter of 50% by volume of the total volume of the particles will upon occasion be simply referred to as the “average particle diameter”. It is more preferable that the 50% volume average particle diameter of the pigment is in a range of 0.20 to 0.50 μm to prevent sticking and generation of noise and the like between a thermal head and the heat-sensitive recording material during recording by using the thermal head.

When the 50% volume average particle diameter of the particles exceed 1.00 μm, the effect of reducing wear of a thermal head decreases. When the 50% volume average particle diameter is less than 0.20 μm, the effect of addition of the pigment, i.e., the effect of preventing adhesion caused by the binder in the protective layer fusing to the thermal head, decreases, and, as a result, so-called sticking, i.e., adhesion of the protective layer of the heat-sensitive recording material to the thermal head, takes place during printing. Therefore, such average particle diameters are not preferable.

The pigment contained in the protective layer is not particularly limited and conventional organic and inorganic pigments can be used. Preferable examples of the pigment include inorganic pigments such as calcium carbonate, titanium oxide, kaolin, aluminum hydroxide, amorphous silica and zinc oxide; and organic pigments such as urea-formaldehyde resins and epoxy resins. Among these pigments, kaolin, aluminum hydroxide and amorphous silica are more preferable. A single type of the pigment or a combination of two or more types of the pigments may be used.

Particularly preferable examples among these pigments include inorganic pigments obtained by coating the surface of the pigment particle with at least one type of compound selected from the group consisting of higher fatty acids, metal salts of higher fatty acids, higher alcohol, and amides of higher fatty acids.

Examples of the higher fatty acids include stearic acid, palmitic acid, myristic acid, lauric acid and the like.

These pigments are preferably dispersed by a conventional dispersing machine such as a dissolver, a sand mill, or a ball mill in the presence of an auxiliary dispersant such as sodium hexametaphosphate, partially or fully saponified modified polyvinyl alcohol, copolymers of polyacrylic acid, and various types of surfactants, preferably a partially or fully saponified modified polyvinyl alcohol or an ammonium salt of a copolymer of polyacrylic acid in such a manner that the average particle diameter has the above-described value, and then used. That is, it is preferable that the pigment is dispersed before use such that the 50% volume average particle diameter of the pigment particles is in the range of 0.20 to 1.00 μm.

To achieve excellent transparency, it is preferable that fully saponified polyvinyl alcohol, carboxy modified polyvinyl alcohol, silica modified polyvinyl alcohol or the like is used as the binder for the protective layer.

The protective layer may contain conventional film hardeners, metal soaps, and the like.

To form a uniform protective layer on the heat-sensitive recording layer, or on the intermediate layer, it is preferable that a surfactant is added to a coating solution for forming the protective layer. Examples of the surfactant include alkali metal salts of sulfosuccinic acid and fluorine-containing surfactants and the like. Specific examples of the surfactant include sodium salts or ammonium salts of di-(2-ethylhexyl) sulfosuccinate, di-(n-hexyl) sulfosuccinate and the like.

Further, to the protective layer, waxes may be added to reduce wear of a recording head, and surfactants, fine particles of metal oxides, inorganic electrolytes, macromolecular electrolytes and the like may be added to prevent electrostatic charge on the heat-sensitive recording material.

The wax preferably has a melting point in the range of 40 to 100° C. and a 50% volume average particle diameter of 0.7 μm or less and more preferably of 0.4 μm or less.

When the average particle diameter exceeds 0.7 μm, transparency of the protective layer deteriorates or obtained images do not come out clearly. Therefore, such a diameter is not preferable.

When the melting point is lower than 40° C., the surface of the protective layer becomes tacky. When the melting point exceeds 100° C., sticking tends to take place. Therefore, such melting points are not preferable.

As the wax having a melting point of 40° C. to 100° C., petroleum waxes such as paraffin wax and microcrystalline wax, synthetic waxes such as polyethylene wax, plant waxes such as candelilla wax, carnauba wax and rice wax, animal waxes such as lanolin, and mineral waxes such as montan wax, can be used. Among these waxes, paraffin wax having a melting point of 55 to 75° C. is particularly preferable.

The wax is preferably used in an amount of 0.5 to 40% by weight and more preferably in an amount of 1 to 20% by weight of the total amount of the protective layer. The wax may be used in combination with derivatives of 12-hydroxystearic acid, higher fatty acid amides, or the like.

To obtain a dispersion of the wax having the above-described 50% volume average particle diameter, the wax may be dispersed by using a conventional wet type dispersing machine such as a dyno mill and a sand mill in the presence of a suitable protective colloid and/or a suitable surfactant. A method in which the wax is heated to melt and then emulsified by stirring at a high speed or by ultrasonic dispersion in a solvent in which the wax is insoluble or slightly soluble at a temperature not lower than the melting point of the wax, or a method in which the wax is dissolved in a suitable solvent and then emulsified in a solvent in which the wax is insoluble or slightly soluble, can also be used to obtain a dispersion having small particles. A suitable surfactant or a suitable protective colloid may be used in combination in the above methods.

The protective layer may have a single layer structure or a laminate structure having two or more layers. The coated amount of the dried protective layer is preferably 0.2 to 7 g/m² and more preferably 1 to 4 g/m².

The heat-sensitive recording layer contains at least a color forming component, and other components if necessary.

The heat-sensitive recording layer may have any composition as long as the layer has excellent transparency before color development and develops color by heating.

Examples of the heat-sensitive recording layer include a so-called two-component heat-sensitive recording layer containing a naturally colorless color forming component A and a naturally colorless color forming component B which forms color by reaction with the color forming component A. It is preferable that either one of the color forming components A and B is micro-encapsulated. Examples of combinations of two components constituting the two-component heat-sensitive recording layer include the following combinations (a) to (m):

(a) Combinations of electron-donating dye precursors with electron-accepting compounds.

(b) Combinations of photodecomposable diazo compounds with couplers.

(c) Combinations of organic metal salts such as silver behenate and silver stearate with reducing agents such as protocatechuic acid, spiroindane and hydroquinone.

(d) Combinations of long chain aliphatic salts such as ferric stearate and ferric myristate with phenols such as gallic acid and ammonium salicylate.

(e) Combinations of heavy metal salts of organic acids such as nickel, cobalt, lead, copper, iron, mercury or silver salt of acetic acid, stearic acid and palmitic acid with alkaline earth metal sulfides such as calcium sulfide, strontium sulfide and potassium sulfide, or combinations of the above heavy metal salts of organic acids with organic chelating agents such as s-diphenylcarbazide and diphenylcarbazone.

(f) Combinations of (heavy) metal sulfates such as silver sulfide, lead sulfide, mercury sulfide and sodium sulfide with sulfur compounds such as sodium tetrathionate, sodium thiosulfate and thiourea.

(g) Combinations of aliphatic ferric salts such as ferric stearate with aromatic polyhydroxy compounds such as 3,4-dihydroxytetraphenylmethane.

(h) Combinations of organic noble metal salts such as silver oxalate and mercury oxalate with organic polyhydroxy compounds such as polyhydroxyalcohol, glycerin and glycol.

(i) Combinations of aliphatic ferric salts such as ferric peralgonate and ferric laurate with derivatives of thiocetylcarbamide and isothiocetylcarbamide.

(j) Combinations of lead salts of organic acids such as lead capronate, lead peralgonate and lead behenate with derivatives of thiourea such as ethylenethiourea and N-dodecylthiourea.

(k) Combinations of heavy metal salts of higher fatty acids such as ferric stearate and copper stearate with zinc dialkyldithiocarbamate.

(l) Forming oxazine dyes such as combination of resorcinol and nitroso compounds.

(m) Combinations of formazane compounds with reducing agents and/or metal salts.

In the heat-sensitive recording material of the present invention, the combinations (a) of electron-donating dye precursors with electron-accepting compounds, combinations (b) of photodecomposable diazo compounds with couplers, or combinations (c) of organic metal salts with reducing agents are preferable. The combinations (a) of electron-donating dye precursors with electron-accepting compounds and the combinations (b) of photodecomposable diazo compounds with couplers are particularly preferable.

In the heat-sensitive recording material of the present invention, images having excellent transparency can be obtained by forming a heat-sensitive recording layer so as to have a decreased haze value which is obtained from the calculation:

(diffused light transmittance/total light transmittance)×100 (%)

The haze value is an index showing the transparency of a material and is generally calculated from the total light transmittance, the diffused light transmittance and the specular light transmittance obtained by using a haze meter.

In the present invention, the haze value can be decreased by a method in which the volume average particle diameter of 50% by volume of each of color forming components A and B contained in the heat-sensitive recording layer is adjusted to 1.0 μm or less and preferably to 0.6 μm or less and a binder is contained in an amount in the range of 30 to 60% by weight of the total solid components of the heat-sensitive recording layer, or by a method in which one of the color forming components A and B is micro-encapsulated and the other is used in a form which forms a substantially continuous layer after application and drying, for example, is used in the form of an emulsion.

It is also effective if the refractivity indices of the components used in the heat-sensitive recording layer are adjusted to be as close to a specific value as possible.

The combinations (a), (b) and (c) which are preferably used in the heat-sensitive recording layer are described in detail hereinafter.

(a) The heat-sensitive recording layer using the combination of an electron-donating dye precursor and an electron-accepting compound is described hereinafter.

The electron-donating dye precursor preferably used in the present invention is not particularly limited as long as the precursor is naturally colorless. The electron-donating dye precursor is a compound having the property of developing color by donating an electron or by accepting a proton from an acid or the like. A colorless compound having a partial skeleton structure of lactone, lactum, sultone, spiropyran, ester or amide which causes an open ring or cleavage of the structure when the compound is brought into contact with an electron-accepting compound is preferably used.

Examples of the electron-donating dye precursor include triphenylmethane phthalide compounds, fluoran compounds, phenothiazine compounds, indolyl phthalide compounds, leuko auramine compounds, rhodamine lactum compounds, triphenylmethane compounds, triazine compounds, spiropyran compounds, fluorene compounds, pyridine compounds and pyrazine compounds.

Specific examples of the phthalide compound include compounds described in U.S. Reissued Patent No. 23,024 and U.S. Pat. Nos. 3,491,111, 3,491,112, 3,491,116 and 3,509,174.

Specific examples of the fluoran compound include compounds described in U.S. Pat. Nos. 3,624,107, 3,627,787, 3,641,011, 3,462,828, 3,681,390, 3,920,510 and 3,959,571.

Specific examples of the spiropyran compounds include compounds described in U.S. Pat. No. 3,971,808.

Specific examples of the pyridine compound and the pyrazine compound include compounds described in U.S. Pat. Nos. 3,775,424, 3,853,869 and 4,246,318.

Specific examples of the fluorene compound include compounds described in Japanese Patent Application No. 61-240989.

In particular, 2-arylamino-3-[H, halogen, alkyl or alkoxy-6-substituted aminofluorans] which form black color are preferable among the above compounds.

Specific examples of the above compound include

2-anilino-3-methyl-6-diethylaminofluoran,

2-anilino-3-methyl-6-N-cyclohexyl-N-methylaminofluoran,

2-p-chloroanilino-3-methyl-6-dibutylaminofluoran,

2-anilino-3-methyl-6-dioctylaminofluoran,

2-anilino-3-chloro-6-diethylaminofluoran,

2-anilino-3-methyl-6-N-ethyl-N-isoamylaminofluoran,

2-anilino-3-methyl-6-N-ethyl-N-dodecylaminofluoran,

2-anilino-3-methoxy-6-dibutylaminofluoran,

2-o-chloroanilino-6-dibutylaminofluoran,

2-p-chloroanilino-3-ethyl-6-N-ethyl-N-isoamylaminofluoran,

2-o-chloroanilino-6-p-butylanilinofluoran,

2-anilino-3-pentadecyl-6-diethylaminofluoran,

2-anilino-3-ethyl-6-dibutylaminofluoran,

2-o-toluidino-3-methyl-6-diisopropylaminofluoran,

2-anilino-3-methyl-6-N-isobutyl-N-ethylaminofluoran,

2-anilino-3-methyl-6-N-ethyl-N-tetrahydrofurfurylaminofluor an,

2-anilino-3-chloro-6-N-ethyl-N-isoamylaminofluoran,

2-anilino-3-methyl-6-N-methyl-N-γ-ethoxypropylaminofluoran,

2-anilino-3-methyl-6-N-ethyl-N-γ-ethoxypropylaminofluoran, and

2-anilino-3-methyl-6-N-ethyl-N-γ-propoxypropylaminofluoran.

Examples of the electron-accepting compound which interacts with the electron-donating dye precursor include acidic substances such as phenol compounds, organic acids, metal salts of organic acids, and esters of oxybenzoic acid, for example, the compounds described in JP-A-61-291183.

Specific examples of the electron-accepting compound include: bisphenols such as 2,2-bis(4′-hydroxyphenyl)propane (generic name: bisphenol A), 2,2-bis (4′-hydroxyphenyl) pentane,

2,2-bis(4′-hydroxy-3′,5′-dichlorophenyl)propane,

1,1-bis(4′-hydroxyphenyl)cyclohexane,

2,2-bis(4′-hydroxyphenyl)hexane,

1,1-bis(4′-hydroxyphenyl)propane,

1,1-bis(4′-hydroxyphenyl)butane,

1,1-bis(4′-hydroxyphenyl)pentane,

1,1-bis(4,hydroxyphenyl)hexane,

1,1-bis(4′-hydroxyphenyl)heptane,

1,1-bis(4′-hydroxyphenyl)octane,

1,1-bis(4′-hydroxyphenyl)-2-methyl-pentane,

1,1-bis(4′-hydroxyphenyl)-2-ethyl-hexane,

1,1-bis(4′-hydroxyphenyl)dodecane,

1,4-bis(p-hydroxyphenylcumyl)benzene,

1,3-bis(p-hydroxyphenylcumyl)benzene,

bis(p-hydroxyphenyl)sulfone,

bis(3-allyl-4-hydroxyphenyl)sulfone and

benzyl bis(p-hydroxyphenyl)acetate;

derivatives of salicylic acid such as

3,5-di-a-methylbenzylsalicylic acid,

3,5-di-tert-butylsalicylic acid,

3-a,a-dimethylbenzylsalicylic acid and

4-(β-p-methoxyphenoxyethoxy)salicylic acid;

salts of the derivatives of salicylic acid with multivalent metals (particularly zinc and aluminum)

esters of oxybenzoic acid such as benzyl p-hydroxy benzoate,

2-ethylhexyl p-hydroxybenzoate, 2-phenoxyethyl

β-resorcylate; and

phenols such as p-phenylphenol, 3,5-diphenylphenol,

cumylphenol, 4-hydroxy-4′-isopropoxy-diphenylsulfone and

4-hydroxy-4′-phenoxy-diphenylsulfone.

Bisphenols are preferable among these compounds from the standpoint of obtaining an excellent color developing property.

A single type or a combination of two or more types of the above electron-accepting compounds may be used.

(b) The combination of a photodecomposable diazo compound and a coupler is described hereinafter.

The photodecomposable diazo compound develops a desired color by the coupling reaction with a coupler which is a coupling component described later. When light having a wavelength of a specific range is irradiated onto the photodecomposable diazo compound before the coupling reaction, the photodecomposable diazo compound is decomposed and loses the ability to develop color even in the presence of the coupling component.

The color hue of this coloring system is decided by the diazo dye produced by the reaction of the diazo compound with the coupler. Therefore, the developed hue can be changed easily by changing the chemical structure of the diazo compound or the coupler. Thus, a desired hue can be obtained by selecting a suitable combination of the diazo compound and the coupler.

As the photodecomposable diazo compound used in the present invention, aromatic diazo compounds are preferable. Specifically, aromatic diazonium salts, diazosulfonate compounds and diazoamino compounds are preferable.

The aromatic diazonium salt may be a compound represented by the following formula:

Ar—N₂⁺X⁻

wherein Ar represents a substituted or unsubstituted aromatic hydrocarbon ring group, N₂⁺ represents a diazonium group and X⁻ represents an acid anion. However, the aromatic diazonium compound is not particularly limited thereto. Aromatic diazonium compounds which exhibit an excellent photofixing property, cause little color stains after fixing and form a stable color developed portion are preferably used.

Many diazosulfonate compounds have come to be known recently and can be obtained by treating corresponding diazonium salts with a sulfite. These compounds are advantageously used in the heat-sensitive recording material of the present invention.

The diazoamino compound can be obtained by coupling a diazo group with dicyandiamide, sarcosine, methyltaurine, N-ethylanthranic acid-5-sulfonic acid, monoethanolamine, diethanolamine or guanidine, and is advantageously used in the heat-sensitive recording material of the present invention.

These diazo compounds are described in detail, for example, in JP-A 2-136286.

Examples of the coupler which is used for the coupling reaction with the above diazo compound include 2-hydroxy-3-naphthoic acid anilide, resorcinol and other compounds described in JP-A 62-146678 and the like.

When the diazo compound and the coupler are used in combination in the heat-sensitive recording layer, a basic substance may be added as the sensitizer to accelerate the reaction by carrying out the coupling reaction in a basic atmosphere.

As the basic substance, a basic substance which is insoluble or slightly soluble in water or which generates an alkali upon heating can be used. Examples of the basic substance include compounds containing nitrogen such as inorganic or organic ammonium salts, organic amines, amides, urea, thiourea, derivatives of urea and thiourea, thiazoles, pyrrols, pyrimidines, piperazines, guanidines, indols, imidazoles, imidazolines, triazoles, morpholines, piperidines, amidines, formazines and pyridines.

Specific examples of these compounds include compounds described in JP-A 61-291183.

(c) The combination of an organic metal salt and a reducing agent is described hereinafter.

Specific examples of the organic metal salt include silver salts of long chain aliphatic carboxylic acids such as silver laurate, silver myristate, silver palmitate, silver stearate, silver arachate and silver behenate; silver salts of organic compounds having imino group such as silver salt of benzotriazole, silver salt of benzimidazole, silver salt of cabazole and silver salt of phthaladinone; silver salts of compounds containing sulfur such as s-alkyl thioglycolates; silver salts of aromatic carboxylic acids such as silver benzoate and silver phthalate; silver salts of sulfonic acids such as silver ethanesulfonate; silver salts of sulfinic acids such as silver o-toluenesulfinate; silver salts of phosphoric acids such as silver phenylphosphate; silver barbiturate; silver saccharinate; silver salt of salicylaldoxime; and mixtures of these compounds.

Among these compounds, silver salts of long chain aliphatic carboxylic acids are preferable and silver behenate is more preferable. Behenic acid may be used in combination with silver behenate.

As the reducing agent, suitable compounds may be used with reference to the descriptions from the 14th line in the lower left column of page 227 to the 11th line in the upper right column of page 229 in the specification of JP-A 53-1020. Among such compounds, mono-, bis-, tris- and tetrakis-phenols, mono- and bis-naphthols, di- and polyhydroxy-naphtalenes, di- and polyhydroxybenzenes, hydroxymonoethers, ascorbic acids, 3-pyrazolidones, pyrazolines, pyrazolones, reducing sugars, phenylenediamines, hydroxylamines, reductons, hydroxamines, hydrazides, amidoximes and N-hydroxyureas are preferably used.

Among these compounds, aromatic organic reducing agents such as polyphenols, sulfonamidophenols and naphthols are more preferable.

To surely achieve sufficient transparency of the heat-sensitive recording material, it is preferable that the combination (a) of an electron-donating dye precursor and an electron-accepting compound or the combination (b) of a photodecomposable diazo compound and a coupler is used for the heat-sensitive recording layer. It is also preferable that either one of the color forming components A and B is used in the form of microcapsules, and it is more preferable that the electron-donating dye precursor or the photodecomposable diazo compound is used in the form of microcapsules.

The method for producing microcapsules is described in detail hereinafter.

Microcapsules can be produced by interfacial polymerization, internal polymerization, external polymerization or the like, and any of these methods can be used.

As described above, it is preferable that the electron-donating dye precursor or the photodecomposable diazo compound is micro-encapsulated for the heat-sensitive recording material. In particular, interfacial polymerization is preferable. Interfacial polymerization is carried out as follows: an oil phase is prepared by dissolving or dispersing the electron-donating dye precursor or the photodecoposable diazo compound, which forms the core of the capsule, in a hydrophobic organic solvent; the prepared oil phase is mixed with an aqueous phase in which a water-soluble polymer is dissolved; the two phases are emulsified and dispersed with each other by a device such as a homogenizer; a polymer substance is formed at the interface of the oil droplets by the reaction induced by heating; and the walls of microcapsules of the polymer are formed.

The reactants for forming the polymer substance are added to the inside and/or the outside of the oil droplets. Specific examples of the polymer substance include polyurethanes, polyureas, polyamides, polyesters, polycarbonates, urea-formaldehyde resins, melamine resins, polystyrenes, styrene-methacrylate copolymers and styrene-acrylate copolymers. Among these polymer substances, polyurethanes, polyureas, polyamides, polyesters and polycarbonates are preferable and polyurethanes and polyureas are more preferable.

For example, when a polyurea is used as the wall material of the microcapsule, the wall of the microcapsule can be easily formed by allowing to react a polyisocyanate such as a diisocyanate, a triisocyanate, a tetraisocyanate and a polyisocyanate prepolymer with a polyamine such as a diamine, a triamine and a tetramine, a prepolymer having two or more amino groups, piperadine, a derivative of piperadine, a polyol or the like in the aqueous phase by the interfacial polymerization method.

A composite wall composed of a polyurea and a polyamide or a composite wall composed of a polyurethane and a polyamide can be prepared by mixing a polyisocyanate, for example, with a second substance which forms the capsule wall by reaction with the polyisocyanate such as an acid chloride, a polyamine and a polyol in an aqueous solution of a water-soluble polymer (the aqueous phase) or in an oil medium (the oil phase) which forms the capsule, dispersing the mixed components to prepare an emulsion and heating the prepared emulsion. This method for preparing a composite wall composed of a polyurea and a polyamide is described in detail in JP-A 58-66948.

As the polyisocyanate compound, compounds having 3 or more functional isocyanate groups are preferable. Bifunctional isocyanate compounds having two functional isocyanate groups may be used in combination.

Specific examples of the polyisocyanate compound include dimers and trimers of diisocyanates (biurets and isocyanurates) which are prepared by using the diisocyanates such as xylylene diisocyanate, hydrogenated xylylene diisocyanate, hexamethylene diisocyanate, tolylene diisocyanate, hydrogenated tolylene diisocyanate and isophorone diisocyanate as the main material; multi-functional adducts of polyols such as trimethylolpropane with bifunctional isocyanates such as xylylene diisocyanate; compounds prepared by introducing macromolecular compounds such as polyethers having active hydrogen atoms, such as polyethylene oxide, into adducts of polyols such as trimethylolpropane with bifunctional diisocyanates such as xylylene diisocyanate; and condensation products of benzene isocyanate with formalin.

The compounds described in JP-A 62-212190, JP-A 4-26189, JP-A 5-317694 and Japanese Patent Application No. 8-268721 are preferable as the polyisocyanate compound.

It is preferable that the polyisocyanate is added so as to provide microcapsules having an average particle diameter in the range of 0.3 to 12 μm and a thickness of the wall in the range of 0.01 to 0.3 μm. The diameter of the dispersed particles is generally in the range of 0.2 to 10 μm.

Specific examples of the polyol and/or the polyamine which is added to the aqueous phase and/or the oil phase as a component which forms the wall of the microcapsule by reaction with the polyisocyanate include propylene glycol, glycerol, trimethylolpropane, triethanolamine, sorbitol and hexamethylenediamine. A polyurethane microcapsule wall is formed when the polyol is added. To increase the reaction rate in the above reaction, it is preferable that the reaction temperature is kept high or that a suitable polymerization catalyst is added.

The polyisocyanate, the polyol, the reaction catalyst and the polyamine used for forming a portion of the wall are described in detail in “Polyurethane Handbook” edited by Keiji Iwata and published by Nikkan Kogyo Shinbun Co, Ltd. (1987).

Metal-containing dyes, electric charge controlling agents such as nigrosin and other optional additives can be contained in the microcapsule wall, if necessary. These additives can be added to the wall during formation of the capsule wall or at any other desired step. A monomer such as a vinyl monomer may be graft polymerized to the capsule wall to control the electric charge at the surface of the wall, if necessary.

It is preferable that a plasticizer suitable for the polymer used as the wall material is used to obtain a microcapsule wall exhibiting excellent permeation of substances at lower temperatures and having an excellent color developing property. The plasticizer preferably has a melting point of 50° C. or higher and more preferably a melting point of 120° C. or lower. Among such plasticizers, a solid plasticizer at an ordinary temperature can be suitably selected and used.

For example, when the wall material is a polyurea or a polyurethane, hydroxy compounds, esters of carbamic acid, aromatic alkoxy compounds, organic sulfonamides, aliphatic amides and arylamides are preferably used.

In the preparation of the oil phase, an organic solvent having a boiling point of 100 to 300° C. is preferably used as the hydrophobic organic solvent used for dissolving the electron-donating dye precursor or the photodecomposable diazo compound and for forming the core of the microcapsule.

Specific examples of the organic solvent include esters, dimethylnaphthalene, diethylnaphthalene, diisopropylnaphthalene, dimethylbiphenyl, diisopropylbiphenyl, diisobutylbiphenyl, 1-methyl-1-dimethylphenyl-2-phenylmethane, 1-ethyl-1-dimethylphenyl-1-phenylmethane, 1-propyl-1-dimethylphenyl-1-phyenylmethane, triarylmethanes such as tritoluylmethane and toluyldiphenylmethane, terphenyl compounds such as terphenyl, alkyl compounds, alkylated diphenyl ethers such as propyl diphenyl ether, hydrogenated terphenyl such as hexahydroterphenyl and diphenyl ethers. Among these solvents, esters are preferably used from the standpoint of stability of the dispersed emulsion.

Examples of the esters include esters of phosphoric acid such as triphenyl phosphate, tricresyl phosphate, butyl phosphate, octyl phosphate and cresyl phenyl phosphate; esters of phthalic acid such as dibutyl phthalate, 2-ethylhexyl phthalate, ethyl phthalate, octyl phathalate and butyl benzyl phthalate; dioctyl tetrahydrophthalate; esters of benzoic acid such as ethyl benzoate, propyl benzoate, butyl benzoate, isopentyl benzoate and benzyl benzoate; esters of abietic acid such as ethyl abietate and benzyl abietate; dioctyl adipate; isodecyl succinate; dioctyl azelate; esters of oxalic acid such as dibutyl oxalate and dipentyl oxalate; diethyl malonate; esters of maleic acid such as dimethyl maleate, diethyl maleate and dibutyl maleate; tributyl citrate; esters of sorbic acid such as methyl sorbate, ethyl sorbate and butyl sorbate; esters of sebacic acid such as dibutyl sebacate and dioctyl sebacate; esters of ethylene glycol such as monoesters and diesters of formic acid, monoesters and diesters of butyric acid, monoesters and diesters of lauric acid, monoesters and diesters of palmitic acid, monoesters and diesters of stearic acid and monoesters and diesters of oleic acid; triacetin; diethyl carbonate; diphenyl carbonate; ethylene carbonate; propylene carbonate; and esters of boric acid such as tributyl borate and tripentyl borate.

Among these esters, tricresyl phosphate is preferable because the emulsion obtained is the most stable when used both singly or in a mixture. The above oils can also be used in combination or in a combination with other oils.

When the solubility of the electron-donating dye precursor or the photodecomposable diazo compound used for the microcapsule in the hydrophobic organic solvent is poor, a solvent having a lower boiling point and exhibiting a better solubility can be used in combination as an auxiliary. Preferable examples of the auxiliary solvent having a lower boiling point include ethyl acetate, isopropyl acetate, butyl acetate and methylene chloride and the like.

When the above electron-donating dye precursor or the photodecomposable diazo compound is used in the heat-sensitive recording layer in the heat-sensitive recording material, the amount of the electron-donating dye precursor is preferably in the range of 0.1 to 5.0 g/m² and more preferably in the range of 1.0 to 3.5 g/m²

The amount of the photodecomposable diazo compound is preferably in the range of 0.02 to 5.0 g/m² and more preferably in the range of 0.10 to 4.0 g/m² from the standpoint of the density of the developed color.

When the amount of the electron-donating dye precursor is less than 0.1 g/m² or the amount of the photodecomposable diazo compound is less than 0.02 g/m², a sufficient density of the developed color is not occasionally obtained. When the amount of the electron-donating dye precursor and that of the photodecomposable diazo compound exceed 5.0 g/m², transparency of the heat-sensitive recording layer occasionally deteriorates.

As the aqueous phase, an aqueous solution prepared by dissolving a water-soluble polymer contained as the protective colloid is used. The above oil phase material is added to the aqueous solution and dispersed to prepare an emulsion by using devices such as a homogenizer. The water-soluble polymer works as a dispersing medium so that a uniformly dispersed emulsion can be obtained easily and the obtained emulsion is stable. A surfactant may be added to at least one of the oil phase and the aqueous phase to make the emulsion more uniformly dispersed and more stable. A conventional surfactant for emulsification can be used as the surfactant. The added amount of the surfactant is preferably 0.1 to 5% and more preferably 0.5 to 2% of the weight of the oil phase.

As the surfactant added to the aqueous phase, surfactants which do not form precipitates or agglomerates by interaction with the protective colloid can be suitably selected from anionic and nonionic surfactants.

Preferable examples of the surfactant include sodium alkylbenzene-sulfonates, sodium alkylsulfates, sodium salt of dioctyl sulfosuccinate and polyalkylene glycols such as polyoxyethylene nonylphenyl ether.

The emulsion can be easily prepared from the oil phase containing the above components and the aqueous phase containing the protective colloid and the surfactant by a means generally used for microemulsification such as high speed stirring and dispersion by ultrasonic waves using a conventional emulsifying apparatus such as a homogenizer, a MantonGaulin, an ultrasonic disperser, a dissolver or a KD mill. After emulsification, the formed emulsion is preferably heated to 30 to 70° C. to accelerate the reaction for forming the wall of the capsule. To prevent agglomeration of the capsules during the reaction, it is preferable that water is added to decrease the probability of collision between the capsules and that sufficient stirring is conducted.

An additional amount of the dispersion may be added during the reaction to prevent agglomeration. Generation of carbon dioxide is observed as the polymerization reaction proceeds, and the formation of the wall of the capsule can be considered to be completed around the time when the formation of carbon dioxide ends. The object microcapsules can be obtained generally after the reaction has continued for several hours.

When capsules are prepared using the electron-donating dye precursor or the photodecomposable diazo compound as the core material, the electron-accepting compound or the coupler may be used in a solid form in combination with the water-soluble polymer, the organic base and other components such as color forming auxiliary agents, by dispersing by a means such as a sand mill. However, it is preferable that, after these components are dissolved into an organic solvent having a high boiling point which is insoluble or slightly soluble in water in advance, the resultant solution is mixed with an aqueous solution of the polymer (the aqueous phase) which contains the surfactant and/or the water-soluble polymer as the protective colloid and the resultant mixture is emulsified by a homogenizer or the like to prepare a dispersed emulsion. A solvent having a low boiling point can be used as an auxiliary agent for dissolution.

The coupler and the organic base may be elsified and dispersed separately or may be mixed together, dissolved into a solvent having a high boiling point and then emulsified and dispersed. The diameter of the particles in the emulsion is preferably 1 μm or less.

The organic solvent with a high boiling point used above can be suitably selected, for example, from oils having a high boiling point which are described in JP-A 2-141279.

It is preferable from the standpoint of stability of the dispersed emulsion that esters are used from among these solvents. Tricresyl phosphate is particularly preferable. A combination of the oils described above or a combination of the oils described above with other oils may also be use.

The water-soluble polymer contained as the protective colloid can be suitably selected from conventional anionic polymers, nonionic polymers and amphoteric polymers. A water-soluble polymer having solubility in water of 5% or more at the temperature of emulsification is preferable. Specific examples of such polymers include polyvinyl alcohol, modified polyvinyl alcohols, polyacrylic amide, derivatives of polyacrylic amide, ethylene-vinyl acetate copolymers, styrene-maleic anhydride copolymers, ethylene-maleic anhydride copolymers, isobutylene-maleic anhydride copolymers, polyvinylpyrolidone, ethylene-acrylic acid copolymers, vinyl acetate-acrylic acid copolymers, derivatives of cellulose such as carboxymethylcellulose and methylcellulose, casein, gelatin, derivatives of starch, gum arabic and sodium alginate.

Among these polymers, polyvinyl alcohol, gelatin and derivatives of cellulose are particularly preferable.

The oil phase is mixed with the aqueous phase preferably in a ratio (the weight of the oil phase/the weight of the aqueous phase) of 0.02 to 0.6 and more preferably in a ratio of 0.1 to 0.4. When the ratio is less than 0.02, the emulsion is excessively dilute due to the excessive amount of the aqueous phase and the emulsion is not suitable for production. When the ratio exceeds 0.6, the emulsion has excessively high viscosity so as to cause inconvenience in handling and a decrease in the stability of the coating solution. Therefore, such ratios are not preferable.

When the electron-accepting compound is used in the heat-sensitive recording material of the present invention, the electron-accepting compound is preferably used in an amount of 0.5 to 30 parts by weight and more preferably 1.0 to 10 parts by weight per 1 part by weight of the electron-donating dye precursor.

When the coupler is used in the heat-sensitive recording material of the present invention, the coupler is preferably used in an amount of 0.1 to 30 parts by weight per 1 part by weight of the diazo compound.

The coating solution for the heat-sensitive recording layer can be prepared, for example, by mixing the microcapsule solution and the dispersed emulsion prepared as described above. The water-soluble polymer used as the protective colloid during preparation of the microcapsule solution and the water-soluble polymer used as the protective colloid during preparation of the dispersed emulsion function as a binder in the heat-sensitive recording layer. A binder other than these protective colloids may also be added, mixed, and used to prepare the coating solution for the heat-sensitive recording layer.

A binder soluble in water is generally used as the binder to be added. Examples of the binder include polyvinyl alcohol, hydroxyethylcellulose, hydroxypropylcellulose, epichlorohydrin modified polyamides, ethylene-maleic anhydride copolymers, styrene-maleic anhydride copolymers, isobutylene-maleic anhydride-salicylic acid copolymers, polyacrylic acid, polyacrylamide, methylol modified polyacrylamide, derivatives of starch, casein and gelatin.

To provide the binder with resistance to water, an agent for providing resistance to water or an emulsion of a hydrophobic polymer, such as a styrene-butadiene rubber latex or an acrylic resin emulsion may be added.

To apply the coating solution for the heat-sensitive recording layer onto a substrate, a conventional method for coating a water-based coating solution or an organic solvent-based coating solution is used. In the heat-sensitive recording material of the present invention, methylcellulose, carboxymethylcellulose, hydroxyethylcellulose, starches, gelatin, polyvinyl alcohol, carboxy modified polyvinyl alcohol, polyacrylamide, polystyrene, copolymers of styrene, polyesters, copolymers containing polyesters, polyethylene, copolymers of ethylene, epoxy resins, acrylate resins, copolymer resins of acrylates, methacrylate resins, copolymer resins of methacrylates, polyurethane resins, polyamide resins or polyvinyl butyral resins may be used to achieve safe and uniform application of the coating solution for the heat-sensitive recording layer onto the substrate and to maintain the strength of the resultant coated layer.

Other components which can be used in the heat-sensitive recording layer will be described hereinafter.

The other components are not particularly limited and can be suitably selected in accordance with the object. For example, conventional heat melting substances, ultraviolet light absorbents and antioxidants can be used.

The heat melting substance may be contained in the heat-sensitive recording layer to improve the response to heat.

Examples of the heat melting substance include aromatic ethers, thioethers, esters, aliphatic amides and ureides.

These compounds are described in JP-A 58-57989, JP-A 58-87094, JP-A 61-58789, JP-A 62-109681, JP-A 62-132674, JP-A 63-151478, JP-A 63-235961, JP-A 2-184489 and JP-A 2-215585.

As the above ultraviolet light absorbent, benzophenone ultraviolet light absorbents, benzotriazole ultraviolet light absorbents, salicylic acid ultraviolet light absorbents, cyanoacrylate ultraviolet light absorbents and oxalic acid anilide ultraviolet light absorbents can be advantageously used. Examples of the above ultraviolet light absorbents are described in JP-A 47-10537, JP-A 58-111942, JP-A 58-212844, JP-A 59-19945, JP-A 59-46646, JP-A 59-109055, JP-A 63-53544, Japanese Patent Publication (hereinafter abbreviated as JP-B) No.36-10466, JP-B-42-26187, JP-B-48-30492, JP-B-48-31255, JP-B-48-41572, JP-B-48-54965, JP-B-50-10726 and U.S. Pat. Nos. 2,719,086, 3,707,375, 3,754,919 and 4,220,711.

As the above antioxidant, hindered amine antioxidants, hindered phenol antioxidants, aniline antioxidants and quinoline antioxidants can be advantageously used. Examples of the antioxidants are described in JP-A 59-155090, JP-A 60-107383, JP-A 60-107384, JP-A 61-137770, JP-A 61-139481 and JP-A 61-160287.

The above-described other components are preferably used in an amount of 0.05 to 1.0 g/m² and more preferably of 0.1 to 0.4 g/m². The other components may be contained in the inside or the outside of the microcapsule.

It is preferable that the heat-sensitive recording layer has a large dynamic range, i.e., a large energy range required to obtain the saturated transmission density D_{T}-max, to obtain high quality images by suppressing fluctuations in the density caused by slight differences in the thermal conductivity between heating elements in the thermal head. It is preferable that the heat-sensitive recording material of the present invention includes such a heat-sensitive recording layer and that the heat-sensitive recording layer can exhibit a transmission density D_{T} of 3.0 with a thermal energy in a range of 90 to 150 mJ/mm².

It is preferable that the heat-sensitive recording layer is formed so that the layer obtained after the coating solution is applied and dried has a weight of 1 to 25 g/m² and has a thickness of 1 to 25 μm.

In the heat-sensitive recording material of the present invention, a transparent substrate is preferably used to obtain a transparent heat-sensitive recording material. Examples of the transparent substrate include synthetic polymer films such as polyester films such as a polyethylene terephthalate film and a polybutylene terephthalate film; a cellulose triacetate films; and polyolefin films such as a polypropylene film and a polyethylene film. The above films can be used as a single film or as a laminate of a plurality of films.

The thickness of the film of the synthetic polymer is preferably in the range of 25 to 250 μm and more preferably in the range of 50 to 200 μm.

The above synthetic polymer films may be colored to a desired hue. As the method for coloring synthetic polymer films, a method in which a dye is mixed with a resin before preparation of a resin film and then a film is formed by using the colored resin, or a method in which a coating solution is prepared by dissolving a dye into a suitable solvent and the prepared coating solution is applied to a transparent colorless resin film by a conventional method such as gravure coating, roller coating or wire coating, can be used. A polyester resin film (such as a polyethylene terephthalate film or a polyethylene naphthalate film) which is prepared by mixing a polyester resin with a blue dye and forming the mixture into a film, and which is then treated by a treatment for improving heat resistance, a stretching treatment and an antistatic treatment, is preferably used.

When the transparent heat-sensitive recording material of the present invention is observed on an illuminating table with the substrate side facing the observer, it is occasionally difficult to discern the images due to haze formed by the light of the illuminating table passing through transparent portions having no images.

To prevent the above phenomenon, it is preferable that a synthetic polymer film which has a blue color in the quadrangular region formed by four points which are a point A (x=0.2805, y=0.3005), a point B (x=0.2820, y=0.2970), a point C (x=0.2885, y=0.3015) and a point D (x=0.2870, y=0.3040) on the chromaticity coordinate system in accordance with the method described in Japanese Industrial Standard Z8701, is used as the transparent substrate.

The heat-sensitive recording material of the present invention can be formed such that an intermediate layer, a primer layer, an ultraviolet light absorbing filter layer, a light reflection preventing layer or the like is provided as the other layer on the substrate.

It is preferable that an intermediate layer is provided on the heat-sensitive recording layer.

The intermediate layer is provided to prevent layer mixing and to cut off gas (e.g., oxygen) which is harmful to image preservability. The binder to be used is not particularly limited and polyvinyl alcohol, gelatin, polyvinyl pyrolidone, derivatives of cellulose and the like can be used depending on the system. Various types of surfactants may also be added in order to facilitate coating. Inorganic fine particles such as mica may be added in an amount of 2 to 20% by weight and more preferably of 5 to 10% by weight of the binder in order to increase gas barrier ability.

In the heat-sensitive recording material of the present invention, it is preferable that the substrate is coated with a primer layer to prevent separation of the heat-sensitive recording layer from the substrate before the substrate is coated with the heat-sensitive recording layer containing the microcapsules and the like and the light reflection preventing layer.

For the primer layer, acrylic ester copolymers, polyvinylidene chloride, SBR and hydrophilic polyesters can be used. The thickness of the layer is preferably 0.05 to 0.5 μm.

When the heat-sensitive recording layer is coated on the primer layer, images recorded on the heat-sensitive recording layer are occasionally deteriorated by the swelling of the primer layer caused by water contained in the coating solution for the heat-sensitive recording layer. Therefore, it is preferable that a hardening agent such as a dialdehyde such as glutaraldehyde or 2,3-dihydroxy-1,4-dioxane or boric acid is used in the primer layer to harden the layer. The hardening agent can be used in an amount suitable for providing a desired hardness, i.e., in an amount in the range of 0.2 to 3.0% by weight of the weight of the material of the primer layer.

On a back surface of the substrate, i.e., the surface at the side opposite to the coating surface of the heat-sensitive recording layer, an ultraviolet light absorbing filter layer may be provided to prevent color fading of the printed image. In the ultraviolet light absorbing filter layer, an ultraviolet light absorbent such as a benzotriazole ultraviolet light absorbent, a benzophenone ultraviolet light absorbent, or a hindered amine ultraviolet light absorbent is contained.

A light reflection preventing layer which contains fine particles having an average particle diameter of 1 to 20 μm and preferably of 1 to 10 μm may be formed on the back surface of the substrate at the side opposite the side at which the heat-sensitive recording layer is coated.

The gloss measured at an incident light angle of 20° C. is preferably adjusted to 50% or less and more preferably to 30% or less by forming the light reflection preventing layer.

As the fine particles contained in the light reflection preventing layer, fine particles of starch obtained from barley, wheat, corn, rice or beans; fine particles of synthetic polymers such as cellulose fibers, polystyrene resins, epoxy resins, polyurethane resins, urea-formaldehyde resins, poly (meth)acrylate resins, polymethyl (meth)acrylate resins, copolymer resins of vinyl chloride or vinyl actate and polyolefins; and fine particles of inorganic substances such as calcium carbonate, titanium oxide, kaolin, smectite clay, aluminum hydroxide, silica and zinc oxide, can be used.

A single type or a combination of two or more types of the fine particulate substances can be used. It is preferable that the fine particulate substance has a refractivity index of 1.45 to 1.75 to achieve excellent transparency of the heat-sensitive recording material.

Although the heat-sensitive recording material of the present invention can be produced favorably by a method of producing the heat-sensitive recording material according to the present invention described below, the present invention is not limited thereto and other methods can be used as well.

Since the coating solution for the protective layer contains the emulsion of silicone oil, which is dispersed such that the average particle diameter is 0.15 μm or less, the heat-sensitive recording material of the present invention has excellent head matching performance and an excellent coated surface without any coating defects. Thus, in particular, the heat-sensitive recording material of the present invention is advantageously used as a recording material in the medical field in which stable formation of high quality images is required.

The method for producing the heat-sensitive recording material of the present invention is described hereinafter.

The method for producing the heat-sensitive recording material of the present invention includes steps of forming a heat-sensitive recording layer on a substrate by coating a coating solution for forming the heat-sensitive recording layer, forming a protective layer by coating a coating solution for forming the protective layer containing at least a pigment and a binder, and forming other layers if necessary.

The heat-sensitive recording layer and the protective layer may be formed simultaneously. In this case, the coating solution for forming the heat-sensitive recording layer and the coating solution for forming the protective layer are coated on the substrate in the same process, so that the heat-sensitive recording layer and the protective layer thereon can be formed in the same process.

According to the method for producing the heat-sensitive recording material of the present invention, an emulsion of silicone oil, which is dispersed such that the average particle diameter is 0.15 μm or less, is contained in the coating solution for forming the protective layer. Accordingly, the emulsion is safe from being damaged by a shear when passing through a pump or a filter when the liquid is being fed, or by an ultrasonic deaerator. As a result, huge oil droplets, which might cause coating defects due to repelling, are not formed. Thus, this method of production is extremely stable.

As the substrate, the above-described substrate which is used for the heat-sensitive recording material of the present invention may be used. As the coating solution for forming the heat-sensitive recording layer, the above-described coating solution for the heat-sensitive recording layer can be used. Similarly, as the coating solution for forming the protective layer, the above-described coating solution for the protective layer containing the pigment and the binder can be used.

Examples of the other layers include other layers such as the above-described intermediate layer and primer layer.

According to the method for producing the heat-sensitive recording material of the present invention, a conventional coating method such as blade coating, air knife coating, gravure coating, roll coating, spray coating, dip coating or bar coating is used to form the primer layer, the heat-sensitive recording layer, the intermediate layer, the protective layer and the like one after another on the substrate.

By using the heat-sensitive recording material producing method of the present invention, the heat-sensitive recording material of the present invention can be produced.

Next, photothermographic materials will be described. The phoththermographic materials are conventional sheet recording materials that can be packed in the package of the present invention.

The photothermographic materials are configured of a support on one surface of which are provided at least a non-photosensitive organic silver salt, a silver-ion reducing agent, and a binder. The organic silver salt and the binder are contained in an image-forming layer. The image-forming layer desirably further comprises a reducing agent for the silver ions of the organic silver salt. The photothermographic material further desirably comprises a photosensitive layer containing a photosensitive silver halide and a binder. The image-forming layer preferably comprises a photosensitive silver halide and functions as a photosensitive layer. In such a photothermographic material, the image-forming layer, preferably the photosensitive image-forming layer, comprises a primary binder in the form of a polymer that permits aqueous application using a coating liquid the solvent of which comprises 30% by weight of water, which is considered environmentally safe; delivers good photographic performance; and has an equilibrium moisture content of less than or equal to 2% by weight at 25° C. and 60% relative humidity. The description below specifically relates to an example of a photothermographic material comprising a photosensitive silver halide in an image-forming layer. The photothermographic material is desirably a monosheet (permitting the formation of an image on the photothermographic material without the use of another sheet such as an image-receiving material). This is particularly effective in a photothermographic materials designed for exposure to red-to-infrared radiation.

The photothermographic material contains a reducing agent for an organic silver salt. The reducing agent for an organic silver salt need only be a substance (preferably an organic substance) that reduces the metallic silver in silver ions. Such reducing agents are described in paragraph nos. 0043 to 0045 in JP-A-11-65021 and from line 34, page 7, to line 12, page 18, of European Patent Publication No. 0803764. Of these, bisphenol reducing agents (for example, 1,1-bis(2-hydroxy-3,5-dimethylphenyl)-3,5,5-trimethylhexane) are preferred. The quantity of reducing agent added is desirably 0.01 to 5.0 g/m², preferably 0.1 to 3.0 g/m². It is desirable for 5 to 50 molar percent, preferably 10 to 40 molar percent, to be added per mol of silver on the surface where the image-forming layer is present. The reducing agent is desirably incorporated into the image-forming layer.

The reducing agent is incorporated into the coating liquid in the form of a solution, dispersed in an emulsion, as solid microparticles, or the like, and can be incorporated into the photothermographic material. In the example of the well-known emulsion dispersion method, the reducing agent is dissolved in an oil such as dibutyl phthalate, tricresyl phosphate, glyceryl triacetate, or diethyl phthalate using a complementary solvent such as ethyl acetate or cyclohexanone and an emulsion dispersion is prepared mechanically. As an example of a solid microparticle dispersion method, a powder of the reducing agent is dispersed in a suitable solvent, such as water, in a ball mill, colloid mill, vibrating ball mill, sand mill, jet mill, roller mill, or by means of ultrasound, to prepare a solid dispersion. In the process, protective colloids (for example, polyvinyl alcohol) and surfactants (for example, anionic surfactants such as sodium triisopropylnaphthalene sulfonate (a mixture of compounds having different substitution sites for three isopropyl groups)) may be employed. Preservatives (for example, benzisothiazolinone sodium salt) may also be incorporated into aqueous dispersions.

The halogen composition of the photosensitive silver halide employed in the photothermographic material is not specifically limited; silver chloride, silver chlorobromide, silver bromide, silver iodobromide, and silver iodochlorobromide may be employed. The halogen composition may be uniformly distributed, may vary in steps, or may vary continuously within the molecule. Silver halide particles having a core/shell structure are preferably employed. Core/shell particles of double to quintuple structure are desirably employed, with those of double to quadruple structure being preferred. Techniques of locally positioning silver bromide on the surface of silver chloride or silver chlorobromide particles are also desirably employed. Methods of forming photosensitive silver halides are well known in the trade. For example, the methods described in Research Disclosure No. 17029, June, 1978, and U.S. Pat. No. 3,700,458 may be employed. Specifically, a method in which a photosensitive silver halide is prepared by adding a silver-providing compound and halogen-providing compound to a gelatin or other polymer solution, and then admixing an organic silver salt may be employed.

The particle size of the photosensitive silver halide is desirably small to decrease clouding after image formation. Specifically, a particle size of less than or equal to 0.20 micrometer is desirable, with 0.01 to 0.15 micrometer being preferred and 0.02 to 0.12 micrometer being of greater preference. What is meant here by the “particle size” is the diameter of a sphere having a volume equal to the silver halide particle when the silver halide particle is a normal cubic or octahedral crystal, or when it is not a normal crystal, such as when it is a spherical particle, rod-shaped particle, or the like; and is the diameter converted to a circle with an area identical to the projected area of the main surface when the silver halide particle is tabular.

The shape of the silver halide particle may be cubic, octahedral, tabular, spherical, rod-shaped, potato-shaped, or the like, with cubic particles being preferred. Silver halide particles with rounded corners are also desirably employed. The mirror index of the outer surface of the photosensitive silver halide particles is not specifically limited. However, the ratio of {100} faces of high spectral sensitization efficiency when a spectral sensitization dye is adsorbed is desirably high. This ratio is desirably greater than or equal to 50 percent, preferably greater than or equal to 65 percent, and more preferably greater than or equal to 80 percent. The ratio of mirror index {100} faces can be calculated by the method described by T. Tani in J. Imaging Sci., 29, 165 (1985) using the adsorption dependence of the {111} faces and the {100} faces in the adsorption of sensitization dyes.

The photosensitive silver halide particles contain group VIII to X metals, or metal complexes, of the Periodic Table of the Elements (showing groups I through XVIII). The group VIII to X metals of the Periodic Table of the Elements employed, or core metals of metal complexes employed, are desirably rhodium, rhenium, ruthenium, osmium, or iridium. A single metal complex may be employed, or two or more complexes of homogeneous or heterogeneous metals may be employed. The preferred content falls within a range of from 1×10⁻⁹ mol to 1×10⁻³ mol per mol of silver. These metal complexes are described at paragraphs 0018 to 0024 in JP-A-11-65021.

Of these, the incorporation of iridium compounds into the silver halide particles is desirable. Examples of iridium compounds are hexachloroiridium, hexaammineiridium, trioxalatoiridium, hexacyanoiridium, and pentachloronitro-syliridium. These iridium compounds are dissolved in a suitable solvent such as water for use. One of the common methods, such as adding a hydrogen halide aqueous solution (such as hydrochloric acid, bromic acid, or hydrofluoric acid) or an alkali halide (such as KCl, NaCl, KBr, or NaBr) may be employed to stabilize the solution of iridium compound. Instead of employing water-soluble iridium, when preparing a silver halide, some other silver halide particle that has been doped with iridium in advance may be added and dissolved. The quantity of iridium compound added desirably falls within a range of from 1×10⁻⁸ mol to 1×10⁻³ mol, preferably within a range of from 1×10⁻⁷ mol to 5×10⁻⁴ mol, per mol of silver halide.

Metal atoms (for example, [Fe(CN)₆]⁴⁻) that can be incorporated into the silver halide particles employed in the photothermographic material, desalting methods, and chemical sensitization methods are described at paragraphs 0046 to 0050 in JP-A-11-84574 and at paragraphs 0025-0031 in JP-A-11-65021. Photosensitive silver halide emulsions may be employed singly or in combinations of two or more (for example, emulsions differing in average particle size, halogen composition, crystal habit, or chemical sensitization conditions) in photothermographic materials. The use of multiple types of photosensitive silver halides of differing sensitivity permits the adjustment of gradation. Examples of such techniques are JP-A-57-119341, JP-A-53-106125, JP-A-47-3929, JP-A-48-55730, JP-A-46-5187, JP-A-50-73627, and JP-A-57-150841. A sensitivity difference of greater than or equal to 0.2 logE is desirably imparted by means of the emulsions.

The quantity of photosensitive silver halide added, expressed as the amount of silver coated per m² of photothermographic material, is desirably from 0.03 to 0.6 g/m², preferably from 0.05 to 0.4 g/m², and more preferably from 0.1 to 0.4 g/m². From 0.01 to 0.5 mol, preferably from 0.02 to 0.3 mol, and more preferably from 0.03 to 0.25 mol of photosensitive silver halide is added per mol of organic silver salt. The methods and conditions for mixing separately prepared photosensitive silver halides and organic silver salts are not specifically limited. There are methods of mixing separately prepared silver halide particles and organic salts in high-speed stirrers, ball mills, sand mills, colloidal mills, vibrating mills, and homogenizers. There are also methods of preparing organic silver salts by mixing photosensitive silver halides that have been prepared based on some timing in the preparation of the organic silver salts.

The silver halide is desirably added to the coating liquid of the image-forming layer from 180 min to immediately prior to coating, or from 60 min to 10 sec prior to coating; there is no specific limitation. Specific methods of mixing include the method of mixing in a tank so as to achieve a desired average retention time calculated from the addition flow rate and the amount of liquid fed to the coater, and the method employing a static mixer described in Chapter 8 of “Liquid Mixing Techniques” by N. Harnby, M. F. Edwards, and A. W. Nienow, translated by K. Takahashi (published by Nikkan Kogyo Shinbunsha, 1989).

Since silver halide particles can be spectrally sensitized in a desired wavelength range when sensitizing dyes suited to use in photothermographic materials are adsorbed onto silver halide particles, sensitizing dyes having spectral sensitivity suited to the spectral characteristics of an exposure light source can be advantageously selected. Sensitization dyes and addition methods are described at paragraphs 0103 to 0109 in JP-A-11-65021, the compounds denoted by general formula (II) in JP-A-10-186572, and from line 38, page 19, to line 35, page 20 of European Patent Publication No. 0803764. The sensitizing dyes are desirably added to the silver halide emulsion in the present invention following the desalting step and prior to coating, more preferably following the desalting step and prior to the start of chemical aging.

Examples of antifogging agents, stabilizers, and stabilizer precursors that can be employed in the photothermographic material are those described at paragraph 0070 of JP-A-10-62899, and from line 57, page 20 to line 7, page 21 in European Patent Publication 0803764. Further, the antifogging agents employed with preference in the photothermographic material are organic halogen compounds. Examples of these are disclosed at paragraphs 0111 to 0112 in JP-A-11-65021. The organic polyhalogen compounds denoted by general formula (II) (specifically, tribromomethylnaphthylsulfone, tribromomethylphenylsulfone, and tribromomethyl(4-(2,4,6-trimethylphenylsulfonyl)phenyl)sulfone) in JP-A-10-339934 are preferred.

The methods described for the incorporation of reducing agents above are preferred examples of methods of incorporating antifogging agents into the photothermographic material. Organic polyhalogen compounds are also desirably added as solid microparticle dispersions. Further examples of antifogging agents are the mercury (II) salt of paragraph 0113, and the benzoic acid of paragraph 0114, of JP-A-11-65021. Azolium salts may also be employed as antifogging agents in the photothermographic material. Examples of azolium salts are the compounds denoted by general formula (XI) of JP-A-59-193447, the compounds described in JP-B-55-12581, and the compounds denoted by general formula (II) in JP-A-60-153039. Azolium salts may be added to any part of the photothermographic material, but are desirably added to the surface layer of the photosensitive layer, and preferably added to the organic silver salt-comprising layer. The azolium salt may be added during any step following the preparation of the coating liquid. When added to the organic silver salt-comprising layer, the azolium salt may be added during any step following the preparation of the organic silver salt to preparation of the coating liquid, with addition after the preparation of the organic silver salt to immediately prior to coating being preferred. The azolium salt may be added by any method in the form of a powder, solution, microparticles, or the like. Further, it may be added as a mixed solution with other additives such as sensitization dyes, reducing agents, and color toners. Any quantity of azolium salt may be added, but from 1×10⁻⁶ mol to 2 mol per mol of silver is desirable, with from 1×10⁻³ mol to 0.5 mol being preferred.

Mercapto compounds, disulfide compounds, and thione compounds may be incorporated to inhibit or promote development, control development, improve spectral sensitization efficiency, improve storage properties before and after development, and the like. These are described at paragraphs 0067 to 0069 in of JP-A-10-62899, in the description of the compounds denoted by general formula (I) and specifically at paragraphs 0033 to 0052 of JP-A-10-186572, and at lines 36-56, page 20 of European Patent Publication 0803764. Of these, mercapto-substituted heteroaromatic compounds are preferred.

Color toners are desirably added to the photothermographic material. Examples of color toners are described at paragraphs 0054 to 0055 in JP-A-10-62899, and lines 23-48, page 21, of European Patent Publication No. 0803764. The compounds of preference are: phthalazinone, phthalazinone derivatives and salts, 4-(1-naphthyl)phthalazinone, 6-chlorophthalazinone, 5,7-dimethoxyphthalazinone, 2,3-dihydro-1,4-phthalazinedione, and other derivatives; combinations with phthalazinone and phthalic acid derivatives (for example, phthalic acid, 4-methylphthalic acid, 4-nitrophthalic acid, and tetrachlorophthalic anhydride); phthalazines (phthalazine, phthalazine derivatives and salts, 4-(1-naphthyl)phthalazine, 6-isopropylphthalazine, 6-t-butylphthalazine, 6-chlorophthalazine, 5,7-dimethoxyphthalazine, 2,3-dihydrophthalazine, and other derivatives); and combinations with phthalazines and phthalic acid derivatives (for example, phthalic acid, 4-methylphthalic acid, 4-nitrophthalic acid, and tetrachlorophthalic anhydride). Combinations with phthalazines and phthalic acid derivatives are preferred.

Plasticizers and lubricants suitable for use in the photosensitive layers of the photothermographic material are described at paragraph 0117 of JP-A-11-65021. Ultra-high contrast agents for forming an ultra-high contrast image are described at paragraph 0118 of the same and with regard to compounds of general formulas (III) to (V) (specifically, compounds 21 to 24) in JP-A-11-91652. Contrast promoting agents are described at paragraph 0102 of JP-A-11-65021.

A surface protecting layer can be provided in the photothermographic material to prevent adhesion of the image forming layer. Surface protective layers are described at paragraphs 0119 to 0120 in JP-A-11-65021. The use of gelatin or polyvinyl alcohol (PVA) as the binder in the surface protective layer is preferred. Examples of PVA are: fully saponified PVA-105 [PVA content of 94.0 weight percent or more, degree of saponification 98.5±0.5 molar percent, sodium acetate content 1.5 weight percent or less, volatile component 5.0 weight percent or less, viscosity (4 weight percent, 20° C.) 5.6±0.4 mPa·s], partially saponified PVA-205 [PVA content of 94.0 weight percent, degree of saponification 88.0±1.5 molar percent, sodium acetate content 1.0 weight percent, volatile component 5.0 weight percent, viscosity (4 weight percent, 20° C.) 5.0±0.4 mPa·s], and modified polyvinyl alcohols in the form of MP-102, MP-202, MP-203, R-1130, R-2105 (the above are names of products manufactured by Curare (K.K.)). The PVA coating quantity (per m² of support) of the protective layer (per layer) is desirably from 0.3 to 4.0 g/m², preferably from 0.3 to 2.0 g/m².

The preparation temperature of the coating liquid of the image forming layer is from 30 to 65° C., preferably greater than or equal to 35° C. and less than 60° C., more preferably from 35 to 55° C. Further, the temperature of the coating liquid of the image forming layer immediately following addition of the polymer latex is desirably maintained at from 30 to 65° C. Further, the reducing agent and organic silver salt are desirably admixed prior to addition of the polymer latex. The organic silver salt-containing fluid or the coating liquid of the thermal image forming layer is desirably a thixotropic liquid. Thixotropy refers to a property whereby a decrease in viscosity accompanies an increase in the shear rate. Any device may be employed to measure viscosity. However, the RFS Fluid Spectrometer manufactured by Rheometrix Far East (Ltd.) is desirably used to take measurements at 25° C. Here, the viscosity at a shear rate of 0.1 s⁻¹ of the organic silver salt-containing fluid or the coating liquid of the thermal image forming layer is desirably from 400 to 100,000 Pa·s, preferably from 500 to 20,000 mPa·s. A viscosity of from 1 to 200 mPa·s is desirable at a shear rate of 1,000 s⁻¹, with from 5 to 80 mPa·s being preferred.

Various systems exhibiting thixotropy are known. These are described in “Lectures on Rheology”, ed. by the Macromolecular Publishing House; “High Polymer Latex”, coauthored by Muroi and Morino (pub. by Macromolecular Publishing House), and the like. A liquid must contain numerous solid microparticles to exhibit thixotropy. Further, thixotropy can be effectively increased by incorporating thickening linear macromolecules, increasing the aspect ratio through the anisotropy of the solid microparticles contained, or by using alkali thickeners or surfactants.

The emulsion may be configured of one or more layers on a support. A single-layer configuration necessarily comprises an organic silver salt, a silver halide, a developer, and a binder, as well as desired added materials such as color toners, coating adjuvants, and other adjuvants. A two-layer configuration necessarily comprises an organic silver salt and silver halide in the first emulsion layer (normally, the layer adjacent to the support), and a number of other components in the second layer. However, a two-layer configuration is also conceivable in which all components are comprised in a single emulsion layer, with the second layer comprised of a protective top coat. In configurations with multicolor photothermographic materials, these two-layer combinations are incorporated for each color. Further, all components may be contained in a single layer such as is described in U.S. Pat. No. 4,708,928. In the case of multidye, multicolor photothermographic materials, each emulsion layer is generally maintained separate from the others by means of a functional or nonfunctional barrier layer between each photosensitive layer, such as described in U.S. Pat. No. 4,460,681.

To enhance tone, prevent the generation of interference fringes when conducting laser exposure, and prevent irradiation, various dyes and pigments may be employed in the photosensitive layer. These are described in detail in International Publication WO98/36322. Preferred dyes and pigments for use in photosensitive layers are anthraquinone dyes, azomethine dyes, indaniline dyes, azo dyes, anthraquinone-based indanthrone pigments (such as C.I. Pigment Blue 60), phthalocyanine pigments (copper phthalocyanine such as C.I. Pigment Blue 15 and nonmetallic phthalocyanines such as C.I. Pigment Blue 16), and lake pigments with dyes such as triarylcarbonyl pigments, indigo, and inorganic dyes (ultramarine, cobalt blue, and the like). These dyes and pigments may be added by any method, such as in solutions, emulsions, solid particle dispersions, and high polymer mordents. The quantity of these compounds employed is determined by the targeted amount of absorption. However, a quantity falling within a range of from 1 microgram to 1 gram per m² of photothermographic material is generally employed.

An antihalation layer may be provided on the side of the photosensitive layer farthest from the light source. Antihalation layers are described at paragraphs 0123 and 0124 in JP-A-11-65021. Color eliminating dyes and base precursors are desirably added to the non-photosensitive layers of the photothermographic layer, causing the non-photosensitive layers to function as filter layers or antihalation layers. Generally, the photothermographic material comprises non-photosensitive layers in addition to photosensitive layers. Based on position, non-photosensitive layers may be classified as (1) protective layers provided on photosensitive layers (on the far side from the support), (2) intermediate layers provided between multiple photosensitive layers or between a photosensitive layer and a protective layer, (3) undercoating layers provided between a photosensitive layer and the support, and (4) back layers provided on the opposite side from photosensitive layers. Filter layers are provided in photothermographic materials as layer (1) or (2). Antihalation layers are provided in photothermographic materials as layer (3) or (4).

Color eliminating dyes and base precursors are desirably added in the same non-photosensitive layer. However, they may also be separately added to two adjacent non-photosensitive layers. Further, a barrier layer may be provided between two non-photosensitive layers. Color eliminating dyes are added to non-photosensitive layers by adding a solution, emulsion, solid microparticle dispersion, or polymer impregnated product to the coating liquid of the non-photosensitive layer. It is also possible to use a polymer mordant to add a dye to a non-photosensitive layer. These methods of addition are identical to the common methods of adding dyes to photothermographic materials. Latexes employed in polymer impregnated products are described in U.S. Pat. No. 4,199,363, West German Patent Publication Nos. 25141274 and 2541230, European Patent Publication No. 029104, and JP-B-53-41091. An emulsification method of adding a dye to a solution of dissolved polymer is described in International Publication WO88/00723.

The quantity of color eliminating dye added is determined by the dye application. Generally, a quantity is employed so that the optical density (absorbance) exceeds 0.1 when measured at the targeted wavelength. The optical density is desirably from 0.2 to 2. The quantity of dye added to achieve such an optical density is generally about from 0.001 to 1 g/m², preferably from about 0.01 to 0.2 g/m². When such a dye is eliminated, it is possible to reduce the optical density to less than or equal to 0.1. Two or more color eliminating dyes may be employed in combination in thermal color-eliminating recording materials and photothermographic materials. Similarly, two or more base precursors may be employed in combination. Photothermographic materials are desirably single-sided photosensitive materials, having at least one photosensitive layer comprising a silver halide emulsion on one side of the support and a back layer on the other side.

Matting agents are desirably added to photothermographic materials to improve carrying properties. Matting agents are described at paragraphs 0126 to 0127 in JP-A-11-65021. Expressed as a coating quantity per m² of photothermographic material, matting agents are desirably applied to from 1 to 400 mg/m², preferably from 5 to 300 mg/m². Further, any degree of matting of the emulsion surface that does not produce a starry effect is adequate. However, a Beck smoothness of greater than or equal to 30 sec and less than or equal to 2,000 sec is desirable, with greater than or equal to 40 sec and less than or equal to 1,500 sec being preferred. The degree of matting of the back layer is such that the Beck smoothness is greater than or equal to 10 sec and less than or equal to 1,200, with a degree of matting greater than or equal to 20 sec and less than or equal to 800 sec being desirable and greater than or equal to 40 sec and less than or equal to 500 sec being preferred. The matting agent is incorporated into the outermost layer of the photothermographic material, the layer functioning as the outermost layer, a layer close to the outermost surface, or the layer functioning as the protective layer. Paragraphs 0128 to 0130 in JP-A-11-65021 describe back layers capable of being employed in photothermographic materials.

Film hardeners may be employed in various layers, such as photosensitive layers, protective layers, and back layers. Examples of film hardeners are described at pages 77 to 87 in T. H. James, “The Theory of the Photographic Process, Fourth Edition” (Macmillan Publishing Co., Inc., 1977). The polyvalent metal ions described in this treatise at page 78; the polyisocyanates described in U.S. Pat. No. 4,281,060 and JP-A-6-208193; the epoxy compounds described in U.S. Pat. No. 4,791,042; and the vinyl sulfone-based compounds described in JP-A-62-89048 are desirably employed.

Film hardeners are added as solutions. The solution is added to the protective layer coating liquid from 180 min to immediately before coating, preferably from 60 min to 10 sec before coating. The mixing method and mixing conditions are not specifically limited. Specific methods of mixing include the method of mixing in a tank so as to achieve a desired average retention time calculated from the addition flow rate and the amount of liquid fed to the coater, and the method employing a static mixer described in Chapter 8 of “Liquid Mixing Techniques” by N. Harnby, M. F. Edwards, and A. W. Nienow, translated by K. Takahashi (published by Nikkan Kogyo Shinbunsha, 1989).

Surfactants are described at paragraph 0132 in JP-A-11-65021. Solvents are described at paragraph 0133 of the same. Supports are described at paragraph 0134 of the same. Static preventing and conductive layers are described at paragraph 0135 of the same. And methods of obtaining color images are described at paragraph 0136 of the same. A transparent support may be dyed with a blue dye (for example, Dye 1 described in the embodiments of JP-A-8-240877) or left transparent. Support undercoating techniques are described in JP-A-11-84574 and JP-A-10-186565. The antistatic layer and undercoating techniques described in JP-A-56-143430, JP-A-56-143431, JP-A-58-62646, and JP-A-56-120519 may be employed.

The photothermographic material is desirably in the form of a monosheet (capable of forming an image on the photothermographic material without the use of another sheet such as an image-receiving material). Oxidation inhibitors, stabilizers, plasticizers, UV absorbents, and coating adjuvants may be added to the photothermographic material. The various additives may be added to both photosensitive layers and non-photosensitive layers. In regard to such additives, reference may be made to International Publication WO98/36322, European Patent Publication 803764, and JP-A-10-186567 and JP-A-10-18568.

The photosensitive layers further desirably comprise ultra-high contrast agents. Ultra-high contrast agents may also be incorporated into non-photosensitive layers. When photothermographic materials are employed in the area of printing-use photography, the reproduction of halftone-based continuous gradient images and line images is important. The use of ultra-high contrast agents improves the reproducibility of halftone images and line images. Ultra-high contrast agents in the form of hydrazine compounds, quaternary ammonium compound, and acrylonitrile compounds (described in U.S. Pat. No. 5,545,515) may be employed. Hydrazine compounds are the ultra-high contrast agents of preference.

Hydrazine compounds include hydrazine (H₂N—NH₂) and compounds in which at least one of the hydrogen atoms of hydrazine has been substituted. The substituent may be an aliphatic group, aromatic group, or heterocyclic group directly bonded to one of the nitrogen atoms of hydrazine, or may be an aliphatic group, aromatic group, or heterocyclic group bonded through a connecting group to one of the nitrogen atoms of hydrazine. Examples of connecting groups are —CO—, —CS—, —SO₂—, —POR— (where R denotes an aliphatic group, aromatic group, or heterocyclic group), —CNH—, or some combination thereof. Hydrazine compounds are described in U S. Pat. Nos. 5,464,738, 5,496,695, 5,512,411, and 5,536,622; JP-B-6-77138 and JP-B-6-93082; and JP-A-6-230497, JP-A-6-289520, JP-A-6-313951, JP-A-7-5610, JP-A-7-77783, and JP-A-7-104426.

Hydrazine compounds may be dissolved in suitable organic solvents and added to the coating liquid of the photosensitive layer. Examples of organic solvents are: alcohols (for example, methanol, ethanol, propanol, fluorinated alcohol); ketones (for example, acetone and methyl ethyl ketone), dimethylformamide; dimethylsulfoxide; and methyl cellosolve. Hydrazine compounds may be dissolved in an oil-based (adjuvant) solvent to obtain a solution that is emulsified into the coating liquid. Examples of oil-based (adjuvant) solvents are dibutyl phthalate, tricresyl phosphate, glyceryl triacetate, diethyl phthalate, ethyl acetate, and cyclohexanone. The solid dispersion of a hydrazine compound may be added to the coating liquid. Hydrazine compounds may be dispersed in known dispersing devices such as ball mills, colloid mills, Manton-Goring, microfluidizers, and ultrasonic dispersing devices.

The quantity of ultra-high contrast agent added is desirably from 1×10⁻⁶ to 1×10⁻² mol, preferably from 1×10⁻⁵ to 5×10⁻³ mol, and more preferably from 2×10⁻⁵ to 5×10⁻³ mol, per mol of silver halide. In addition to ultra-high contrast agents, contrast promoting agents may also be employed. Examples of contrast promoting agents are amine compounds (described in U.S. Pat. No. 5,545,505), hydroxamic acid (U.S. Pat. No. 5,545,507), acrylonitriles (U.S. Pat. No. 5,545,507), and hydrazine compounds (U.S. Pat. No. 5,558,983).

The photothermographic material may be exposed by any method, but a laser beam is the exposure light source of preference. Preferred laser beams are: gas lasers (Ar⁺, He—Ne), YAG laser, pigment lasers, and semiconductor lasers. Semiconductor lasers may be used in conjunction with a second high-frequency generating element. A red-to-infrared emitting gas or semiconductor laser is preferred. The laser beam may be in the form of a single-mode laser, and the technique described in JP-A-11-65021 may be employed. The laser output is desirably greater than or equal to 1 mW, with an output of greater than or equal to 10 mW being preferred and a high output of greater than or equal to 40 mW being of even greater preference. In this process, multiple lasers may be combined. The diameter of the laser beam can be made about 30 to 200 micrometers, or 1/e² the spot size of a Gaussian beam. An example of a laser imager equipped with exposure element and heat-developing element is the Fuji Medical Dry Laser Imager FM-DPL.

The photothermographic material forms a black-and-white image based on a silver image, and is desirably employed as a photothermographic material for medical diagnosis, a photothermographic material for industrial photography, a photothermographic material for printing, or a photothermographic material for COM. In these uses, based on the formation of black and white images, the heat developed photosensitive material may be employed as a mask in medical diagnosis when forming a duplicate image on duplication-use film MI-Dup manufactured by Fuji Photo Film Co. (Ltd.) and when forming images on restoration film DO-175 and PDO-100 manufactured by Fuji Photo Film Co. (Ltd.) for printing, and offset printing plates.

The present invention will be specifically explained with reference to the following examples and comparative examples. The materials, amounts, ratios, types and procedures of processes and so forth shown in the following examples can be optionally changed so long as such change does not depart from the spirit of the present invention. Therefore, the scope of the present invention should not be construed in a limitative way based on the following examples.

### MANUFACTURING EXAMPLE 1

### Preparation of an Inner Carton (1) for Heat-Sensitive Recording Materials

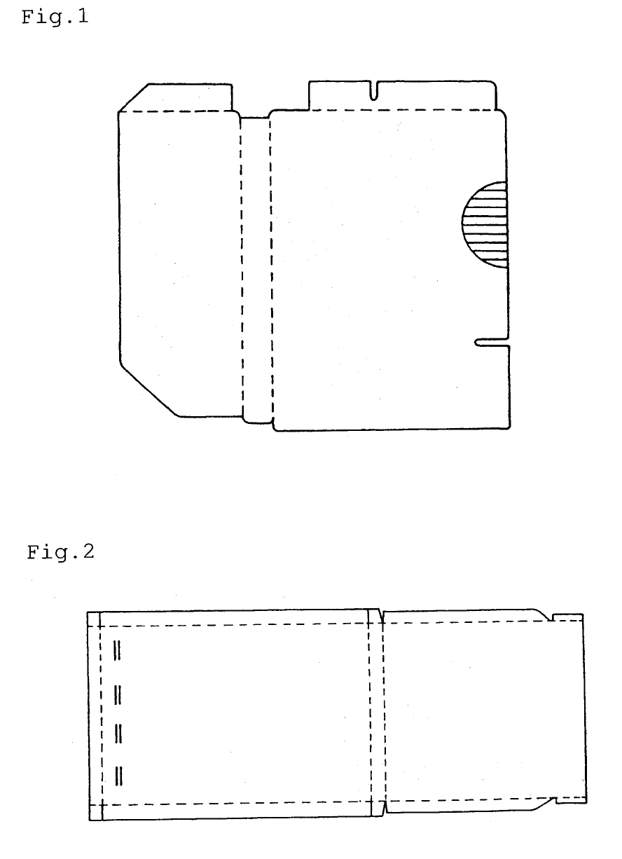

Titanium oxide-containing polypropylene sheet of 550 micrometers in thickness (manufactured by Achilles (Ltd.)) was punched to form a sheet having the shape shown in the plan view of FIG. 1.

The sheet obtained was passed through cleaning rolls manufactured by Technek Co. (Ltd.) at 1 m/sec, folded along the ruled lines, and pressed at the four corners by ultrasound to prepare the inner carton (1) for heat-sensitive recording materials.

### MANUFACTURING EXAMPLE 2

### Preparation of an Inner Carton (2) for Heat-Sensitive Recording Materials

An inner carton (2) for heat-sensitive recording materials was prepared by the same method as in Manufacturing Example 1 with the exception that processing of the sheet by cleaning rolls was omitted. The inner carton (2) for heat-sensitive recording materials was placed in a room at 23° C. and 45% RH for 24 h to adjust the moisture content to 6.5% by weight.

### MANUFACTURING EXAMPLE 3

### Preparation of Protective Carrier (1) for Photothermographic Material

Neutral paper with a basic weight of 310 g/m² (LBKP/NBKP=70/30) (Prime 311 manufactured by Strienso Co.) was punched to prepare a sheet having the shape shown in the plan view of FIG. 2.

The sheet obtained was passed through cleaning rolls manufactured by Technek Co. (Ltd.) at 1 m/sec and folded along the ruled lines to prepare the protective carrier (1) for photothermographic recording materials. Drying was then conducted for 3 days in a 50° C. oven to adjust the moisture content to 4% by weight.

### MANUFACTURING EXAMPLE 4

### Preparation of Protective Carrier (2) for Photothermographic Materials

A protective carrier (2) for photothermographic materials was prepared in the same manner as in Manufacturing Example 3 with the exception that processing of the sheet with cleaning rolls was omitted.

### MANUFACTURING EXAMPLE 5

### Preparation of Sheet for Sealed Packing

A mixture of the composition given in the table below was drawn to 40 micrometers to obtain Film A.

TABLE 1

| Component | Weight percent |
|---|---|
| Furnace carbon black (light-blocking | 5.0 |
| substance) | |
| (Manufactured by firing a starting | |
| material in the form of naphtha with ethylene | |
| bottom oil at 1,250 to 1,600° C. in a furnace. | |
| pH 8.0, average particle diameter 20 nm, | |
| volatile component 0.6%, sulfur content 0.05%, | |
| free sulfur content less than or equal to 20 ppm) | |
| Erucic acid amide (lubricant) | 0.05 |
| Calcium stearate (lubricant) | 0.5 |
| Hindered phenol-based oxidation inhibitor | 0.05 |
| (melting point greater than or equal to 110° C.) | |
| Ethylene/4-methylpentene-1 copolymer resin | 79.4 |
| (MFR 2.0 g/10 sec, density 0.920 g/cm³) | |
| Homopolyethylene resin (MFR 2.4 g/10 min, | 15 |
| density 0.921 g/cm³) | |

Film A was employed and lamination was conducted in the following order to obtain a sealed packing sheet.

| Layer | Thickness |
|---|---|
| Film A | 40 |
| Biaxially oriented polyester resin film (slide | 9 |
| angle 19 degrees) | |
| Extrusion laminate adhesive layer of | 13 |
| homopolyethylene resin (MFR 4.5 g/10 min, | |
| density 0.918 g/cm³) | |
| Dry laminate adhesive layer | 2 |
| Soft aluminum foil | 6.5 |
| Biaxially drawn nylon 6 resin film | 12 |

### EXAMPLE 1

The heat-sensitive recording material described in Example 1 of JP-A-2000-355164 was cut to 257×364 mm in a degree of cleanliness class 500 room as measured by U.S. Federal Standard 209d. Then, 150 sheets were stacked and the stack was stored in the inner carton (1) for heat-sensitive recording materials prepared in Manufacturing Example 1 (FIG. 3).

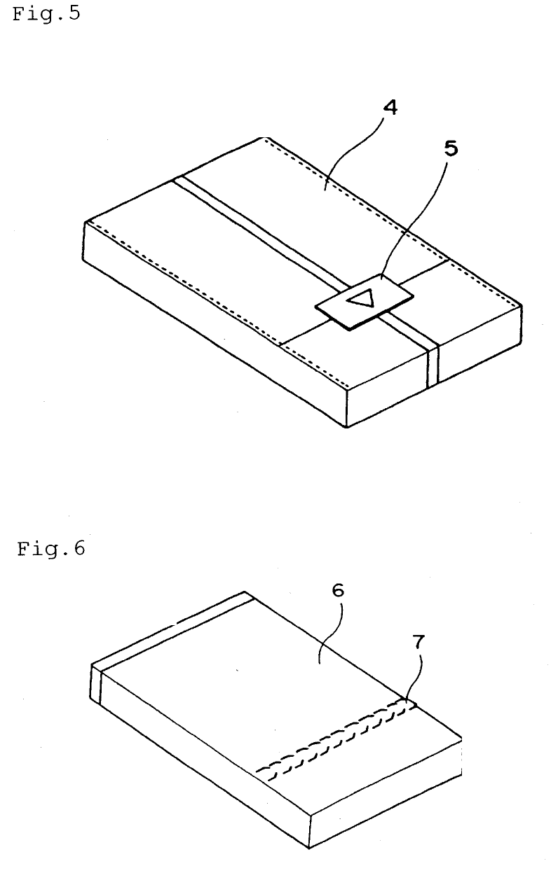

The inner carton (1) for heat-sensitive recording materials containing 150 sheets of heat-sensitive recording material was inserted into a packing bag made out of the sheet for sealed packing prepared in Manufacturing Example 5. The packing bag was degassed under reduced pressure and the two ends thereof were heat sealed (FIG. 4). The weight and volume of the package obtained were measured and the weight in water was measured. From these measurement results, the volume of air V in the light-blocking bag was calculated by Archimedes' method. The air content L in the light-blocking bag calculated according to the equation above was 270.

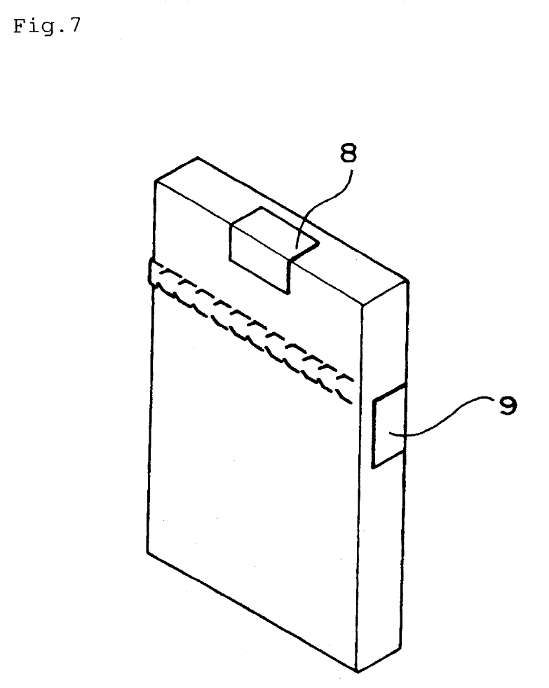

Then, as shown in FIG. 5, the two ends were folded up and a label was affixed. Subsequently, the package was packed into a zippered cosmetic box 6 (the zipper being denoted by numeral 7) as shown in FIG. 6 in a degree of cleanliness class 10,000 room as measured by U.S. Federal Standard 209d. As shown in FIG. 7, a sealing tape (or a label) 8 for preventing tampering and a quality-indicating label 9 were then affixed. The material of zippered cosmetic box 6 was E cardboard (inner and outer liners made of unbleached Kraft pulp cardboard with a base weight of 210 g/m², core E flute made of semikraft pulp cardboard with a base weight of 180 g/m²).

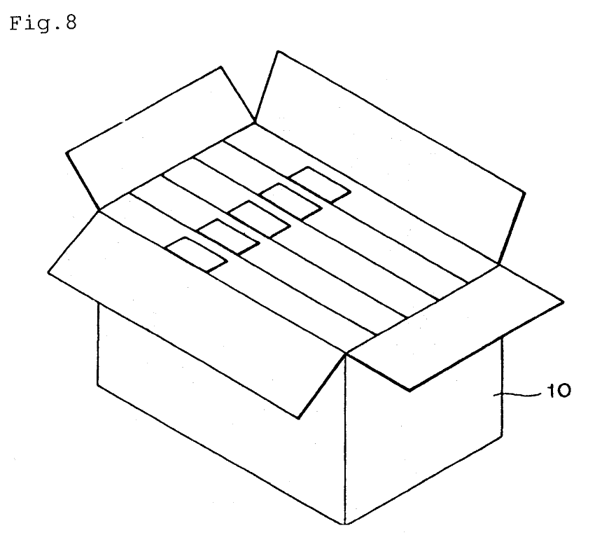

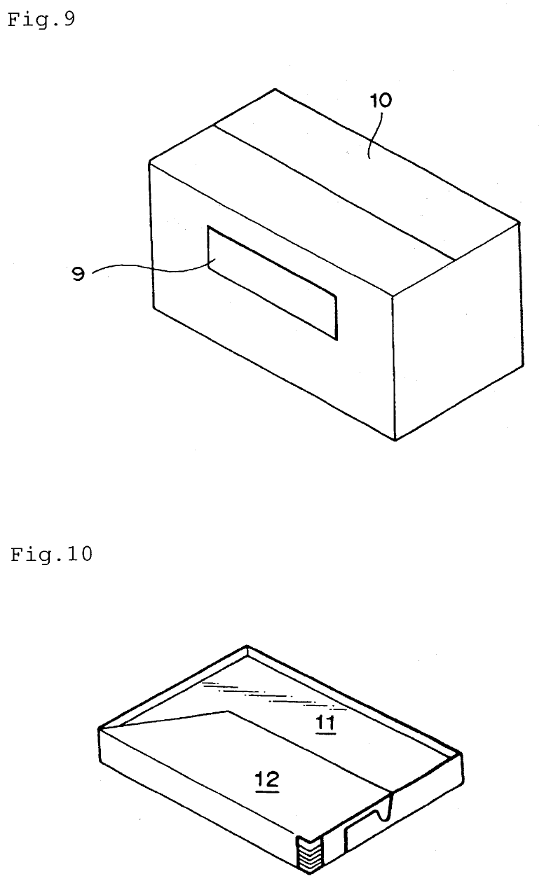

As shown in FIG. 8, five of cardboard boxes 10 were packed into zippered cosmetic box 6. As shown in FIG. 9, the flaps of cardboard box 10 were sealed with a hot melt adhesive and the product name, use period, lot number, and product code were displayed to obtain a heat-sensitive recording material package. This series of operations was conducted at 23° C. and a relative humidity of 50%.

### EXAMPLE 2

A heat-sensitive recording material package was prepared in precisely the same manner as in Example 1 with the exception that the inner carton (2) for heat-sensitive recording materials that was manufactured in Manufacturing Example 2 was employed instead of inner carton (1) for heat-sensitive recording materials. The air content L in the light-blocking bag was 280.

### EXAMPLE 3

The photothermographic material described in Example 1 of JP-A-2001-109112 was cut to 257×364 mm in a degree of cleanliness class 3,000 room as measured by U.S. Federal Standard 209d, 150 sheets were stacked, and the stack was stored in the protective carrier (1) for photothermographic materials prepared in Manufacturing Example 3 (FIG. 10).

The inner carton (1) for heat-sensitive recording materials containing 150 sheets of heat-sensitive recording material was inserted into a packing bag made out of the sheet for sealed packing prepared in Manufacturing Example 5. The packing bag was degassed under reduced pressure and the two ends thereof were heat sealed (FIG. 4). The air content L in the light-blocking bag calculated by the same method as in Example 1 was 330. Then, as shown in FIG. 5, the two ends were folded up and a label was affixed.

Subsequently, the package was packed into a zippered cosmetic box 6 (the zipper being denoted by numeral 7) as shown in FIG. 6 in a degree of cleanliness class 20,000 room as measured by U.S. Federal Standard 209d. As shown in FIG. 7, a sealing tape (or a label) 8 for preventing tampering and a quality-indicating label 9 were then affixed. The material of zippered cosmetic box 6 was E cardboard (inner and outer liners made of unbleached Kraft pulp cardboard with a base weight of 210 g/m², core E flute made of semikraft pulp cardboard with a base weight of 180 g/m²).

As shown in FIG. 8, five of cardboard boxes 10 were packed into zippered cosmetic box 6. As shown in FIG. 9, the flaps of cardboard box 10 were sealed with a hot melt adhesive and the product name, use period, lot number, and product code were displayed to obtain a heat-sensitive recording material package. This series of operations was conducted at 23° C. and a relative humidity of 50%.

### EXAMPLE 4

A photothermographic material package was prepared in precisely the same manner as in Example 3 with the exception that the protective carrier (2) for photothermographic materials that was manufactured in Manufacturing Example 4 was employed instead of protective carrier (1) for photothermographic materials.

### EXAMPLE 5

A photothermographic material package was obtained by the same method as in Example 3 using the photothermographic material described in Example 1 of JP-A-2002-311538 and Sample 004 described in Example 1 of JP-A-2002-156727 instead of the photothermographic material described in Example 1 of JP-A-2001-109112.

### COMPARATIVE EXAMPLE 1

A heat-sensitive recording material package was obtained by the same method as in Example 1 with the exception that cutting of the heat-sensitive recording material was conducted in a degree of cleanliness class 20,000 room and the packing into the inner carton was conducted in a degree of cleanliness class 20,000 room as measured by U.S. Federal Standard 209d.

### COMPARATIVE EXAMPLE 2

A heat-sensitive recording material package was obtained by the same method as in Example 3 with the exception that cutting of the photothermographic material was conducted in a degree of cleanliness class 30,000 room and the packing into the inner carton was conducted in a degree of cleanliness class 30,000 room as measured by U.S. Federal Standard 209d.

### TEST EXAMPLE 1

(1) Evaluation of Image Impairment

Each of the 150 sheets (one sealed pack) from the package obtained was recorded at an image density of 1.2 and the number of void defects was counted. No practical problem was considered to exist when the number of image impairments was less than or equal to 450/150 sheets.

Recording of heat-sensitive recording materials was conducted with a Fuji Medical Dry Imager DRYPIX1000CR (manufactured by Fuji Photo Film (Ltd.)).

Recording of photothermographic materials was conducted with a Fuji Medical Dry Imager FM-DPL (660 nm semiconductor laser recording, development of about 120°) (manufactured by Fuji Photo Film (Ltd.)).

(2) Evaluation of Scratches Due to Rubbing

The packages obtained were vibrated back and forth under conditions of a frequency varying from 0 to 50 Hz with an amplitude of 1 cm and 12 subfrequencies back and forth along the X, Y, and Z axes.

The film in contact with the inner carton or protective carrier was recorded at an image density of 1.2 by the above-described method and the number of scratches due to rubbing was counted. No practical problem was considered to exist of with a number of scratches due to rubbing of less than or equal to 20/sheet.

(3) Evaluation of Photographic Properties

The packages obtained were stored for 1 year in a room at 20° C.±3° C.±65%±5% RH. The above-described image formation was conducted before and after storage. The density (Dmin) of nonimage portions was measured with a densitometer (Macbeth TD904) and the increase in Dmin following storage was calculated.

The results are presented in the table below.

TABLE 3

| | | U.S. Federal | | | Evaluation | | |
|---|---|---|---|---|---|---|---|
| | | Standard 209d class | | Whether | Number of | Scratches | |
| | | During | | packing | image | due to | |
| | | cutting of | When | materials | impairments | rubbing | |
| | | recording | stored in | were | (per 100 | (per single | Increase |
| | Recording material | material | box | cleaned | sheets) | sheet) | in Dmin |
| Embod. 1 | Heat-sensitive recording material | 500 | 10,000 | Yes | 115 | 3 | 0.01 |
| Embod. 2 | Heat-sensitive recording material | 500 | 10,000 | No | 218 | 9 | 0.01 |
| Embod. 3 | Photothermographic material | 3,000 | 20,000 | Yes | 98 | 3 | 0.02 |
| Embod. 4 | Photothermographic material | 3,000 | 20,000 | No | 163 | 11 | 0.02 |
| Comp. Ex. 1 | Heat-sensitive recording material | 20,000 | 20,000 | Yes | 683 | 45 | 0.01 |
| Comp. Ex. 2 | Photothermographic material | 20,000 | 30,000 | Yes | 591 | 56 | 0.02 |

The results of image impairment evaluation and scratching due to rubbing evaluation of the package of Example 5 revealed that a level of no practical problems identical to that of Example 3 was achieved.

Based on the method of the present invention, it is possible to cut and pack sheet recording materials without generating image defects during use. Thus, the present invention can be effectively employed in medical sheet recording materials and in the domain of high-quality images.

The present disclosure relates to the subject matter contained in Japanese Patent Application No. 070346/2002 filed on Mar. 14, 2002, Japanese Patent Application No. 090893/2002 filed on Mar. 28, 2002, and Japanese Patent Application No. 032352/2003 filed on Feb. 10, 2003, which are expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A method of packing sheet recording materials comprising the step of cutting the sheet recording materials to a prescribed size and the step of packing the cut sheet recording materials into a packing material, wherein the cutting step and/or packing step are conducted in an environment with a degree of cleanliness of less than or equal to class 10,000 of U.S. Federal Standard 209d.

2. The method of packing sheet recording materials according to claim 1, wherein the degree of cleanliness during the cutting step is less than or equal to class 500 as measured by U.S. Federal Standard 209d.

3. The method of packing sheet recording materials according to claim 1, wherein said sheet recording material is a photothermographic material or a heat-sensitive recording material.

4. The method of packing sheet recording materials according to claim 1 wherein said packing material is cleaned before the packing step.

5. A sheet recording material package packed by the packing method described in claim 1.
